(19) United States
(12) Patent Application Publication
(10) Pub. No.: US 2018/0042039 A1
(43) Pub. Date: Feb. 8, 2018

(54) APPARATUS AND METHOD FOR CONTROLLING TRANSMISSION OF INFORMATION

(71) Applicant: FUJITSU LIMITED, Kawasaki-shi (JP)

(72) Inventors: Teruhiko SENBA, Nasushiobara (JP); Kiyoshi MIYAZAWA, Yokohama (JP)

(73) Assignee: FUJITSU LIMITED, Kawasaki-shi (JP)

(21) Appl. No.: 15/663,935

(22) Filed: Jul. 31, 2017

(30) Foreign Application Priority Data
Aug. 4, 2016 (JP) 2016-153972

(51) Int. Cl. H04W 72/12; H04W 4/04; H04L 12/851

(52) U.S. Cl. CPC H04W 72/1242; H04L 47/24; H04W 4/046; H04W 4/027

(57) ABSTRACT

An information processing apparatus includes a processor that executes processing including setting a priority degree of transmission of information to be notified to each of a plurality of terminals including an in-vehicle terminal and terminals carried by pedestrians based on position information of the plurality of terminals and transmitting the information to the terminal having a predetermined priority degree among the plurality of terminals when it is determined that the information needs to be transmitted based on a position of the in-vehicle terminal.

### CROSS-REFERENCE TO RELATED APPLICATION

This application is based upon and claims the benefit of priority of the prior Japanese Application No. 2016-153972 filed on Aug. 4, 2016, the entire contents of which are incorporated herein by reference.

### FIELD

The present invention relates to an apparatus and a method for controlling transmission of information.

### BACKGROUND

Practical application of a driving support system utilizing an in-vehicle sensor has been started for a purpose of preventing traffic accidents, mitigating congestion, supporting driving by aged people or the like. In addition, development of a system that acquires information which is difficult to be captured just by an in-vehicle sensor by using road-vehicle communication and vehicle-vehicle communication and supports safe driving is underway. Further, development of pedestrian-vehicle communication that notifies a pedestrian and a vehicle of an approach and danger of a collision or the like is also underway.

A pedestrian-vehicle communication system is a system that notifies an automobile driver of presence, an approach and danger of a pedestrian and a pedestrian of those of an automobile by communication between a vehicle and a pedestrian, thereby preventing traffic accidents.

For further information, see Japanese Laid-Open Patent Publication No. 2009-15494, Japanese Laid-Open Patent Publication No. 2002-304700, and Japanese Laid-Open Patent Publication No. 2013-120573.

### SUMMARY

As a pedestrian-vehicle communication, it is conceivable to utilize a mobile communication network for which infrastructure is improved at present. For example, it is conceivable to collect each position information from a mobile terminal (terminal, hereinafter), determine danger based on a position and notify each terminal of an alarm. However, since it takes time to notify each of the plurality of terminals, there is a possibility that arrival timing of the alarm to the terminal is delayed.

An aspects of embodiments is an information processing apparatus includes a memory and a processor coupled to the memory and configured to set a priority degree of transmission of information to be notified to each of a plurality of terminals including an in-vehicle terminal and terminals carried by pedestrians based on position information of the plurality of terminals, and transmit the information to the terminal having a predetermined priority degree among the plurality of terminals when it is determined that the information needs to be transmitted based on a position of the in-vehicle terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram illustrating one example of an information notification system;

FIG. 2 illustrates a configuration example of a base station;

FIG. 3 illustrates a configuration example of a terminal (mobile terminal, in-vehicle terminal);

FIG. 4 illustrates a configuration example of an information processing apparatus usable as a server or the like;

FIG. 5 is an explanatory drawing of a protocol stack of communication relating to the terminal, the base station, an SGW, a PGW and the server;

FIG. 6 is a flowchart illustrating one example of processing executed by the server;

FIG. 7 is a flowchart illustrating one example of first determination processing;

FIG. 8 is a flowchart illustrating one example of second determination processing;

FIG. 9 is a flowchart illustrating a processing example in a terminal 1;

FIG. 10 is a diagram illustrating one example of a danger notification system relating to an embodiment 2;

FIG. 11 is a flowchart illustrating one example of necessity determination of danger notification based on road information;

FIG. 12 is a flowchart illustrating one example of the necessity determination of the danger notification based on intersection information (included in the road information);

FIG. 13 is a flowchart illustrating a processing example of a server 6 in the embodiment 2;

FIG. 14 is a flowchart illustrating a processing example relating to notification of danger from the rear;

FIG. 15 is a flowchart illustrating a processing example relating to notification of a position of a dangerous person;

FIG. 16 is a flowchart illustrating a processing example of the terminal relating to notification of a position of a dangerous person;

FIG. 17 schematically illustrates a configuration example in the case of an embodiment 3 (danger determination control in a base station);

FIG. 18 is an explanatory drawing of a MAC-PDU;

FIG. 19 is a table explaining a MAC header;

FIG. 20A is a table illustrating a value of an LCID of a DL-SCH;

FIG. 20B is a table illustrating a value of an LCID of an UL-SCH;

FIG. 21 illustrates a format example of an optional MAC-SDU(DL) corresponding to the LCID of the danger notification;

FIG. 22 illustrates a format example of the MAC-SDU mounted on an uplink MAC-PDU for which the LCID of “information report” is imparted to the MAC header, which is transmitted from an in-vehicle terminal;

FIG. 23 illustrates a format example of the MAC-SDU mounted on the uplink MAC-PDU for which the LCID of “information report” is imparted to the MAC header, which is transmitted from the terminal of a pedestrian;

FIG. 24 is a flowchart illustrating a processing example when transmitting a dataset in the terminal 1; and

FIG. 25 is a flowchart illustrating a processing example when receiving the MAC-PDU in a base station 2.

### DETAILED DESCRIPTION OF EMBODIMENTS

Hereinafter, an information processing apparatus (information transmission control device) and an information transmission control method relating to an embodiment with reference to the drawings. However, a configuration of the embodiment is an example, and the present invention is not limited to the configuration of the embodiment.

### Embodiment 1

### <System Configuration Example>

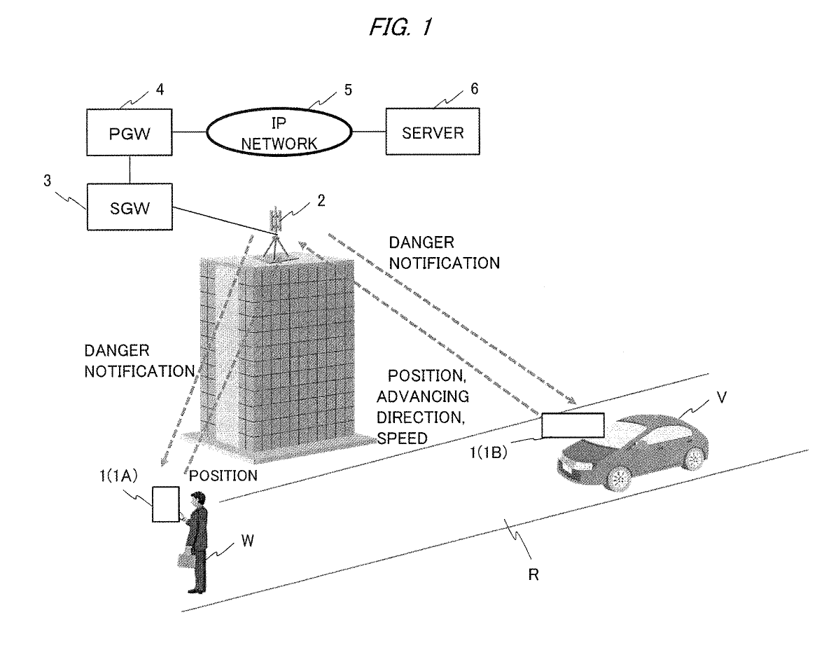

FIG. 1 illustrates one example of an information notification system that notifies each of a plurality of terminals of information. The information is information indicating danger for example, and the information notification system is used as a danger notification system as one example. Danger notification is one example “transmission of information”. FIG. 1 illustrates a wireless communication system applied to or based on Long Term Evolution (LTE) which is one example of a wireless communication standard applicable to the danger notification system. However, the wireless communication standard may be a standard other than the LTE, for example a Wideband Code Division Multiple Access (WCDMA(R)) or the like.

The wireless communication system includes a mobile terminal 1A (terminal 1A, hereinafter) owned by a pedestrian W, an in-vehicle terminal 1B (terminal 1B, hereinafter) loaded in a vehicle V traveling on a roadway R, and a base station 2 communicable with the terminal 1A and the terminal 1B. The base station 2 is installed at a high place (on a roof of a building, for example) near an intersection as an example. The in-vehicle terminal 1B is an in-vehicle dedicated terminal. In the case that the mobile terminal 1A is loaded in the vehicle V, the mobile terminal 1A can be handled as the in-vehicle terminal. The in-vehicle terminal 1B and the mobile terminal 1A loaded in the vehicle are examples of “a terminal loaded in a vehicle”, and the mobile terminal 1A owned by the pedestrian W is an example of “a terminal carried by a pedestrian”.

One each of the terminal 1A and the terminal 1B is illustrated as an example. However, the base station 2 is communicable with a plurality of terminals including the terminal 1A and the terminal 1B. In the following description, in the case of not distinguishing the terminal 1A and the terminal 1B, they are described as terminals 1.

The terminal 1 (terminal 1A, terminal 1B) communicates with a server 6 connected to an IP network 5 through an LTE network. The server 6 determines danger of a collision or the like based on information obtained from the terminal 1, determines a priority degree to the terminal 1, and sends notification notifying the terminal 1 having a predetermined priority degree of the danger.

Each terminal 1 is connected with the server 6 through the base station 2, a Serving GateWay (SGW) 3, a Packet data Network GateWay (PGW) 4, and the IP (Internet Protocol) network 5. The server 6 is an example of “an information processing apparatus”.

The LTE network includes a wireless network and a core network, and the base station 2 forms the wireless network. The SGW 3 and the PGW 4 are network nodes included in the core network. The SGW 3 transfers user data (packet) from the wireless network (base station 2). The PGW 4 is a connection point with an external network like the IP network 5.

When the terminal 1 connected with the base station 2 requests communication with the server 6, a control device (called a Mobility Management Entity (MME) (not illustrated in the figure)) included in the core network registers positions of the terminal 1A and the terminal 1B. After position registration, the MME establishes a channel of packets called a bearer between the PGW 4 and the SGW 3 and between the SGW 3 and the base station 2.

A wireless bearer is set between the base station 2 and the terminal 1. The packet transmitted from the terminal 1 passes through the wireless bearer and the bearer and reaches the PGW 4. The PGW 4 sends the packet to the server 6 through the IP network 5. The packet transmitted from the server 6 is received by the terminal 1 through a reverse route.

The terminal 1A transmits pedestrian information including position information of the terminal 1A to the server 6. The terminal 1B transmits vehicle information including the position, an advancing direction and a moving speed (vehicle speed) of the terminal 1B (vehicle V) to the server 6.

The server 6 performs determination processing of necessity of danger notification using the vehicle information. For example, in the case that there is a vehicle predicted to enter an intersection without speed reduction using the vehicle information, it is determined that the danger notification is needed. However, the necessity of the danger notification may be determined using the vehicle information and the pedestrian information. The danger is an example of information, and the danger notification is an example of the transmission of the information.

In addition, the server 6 sets the priority degree of the danger notification (one example of the transmission of the information) to each terminal 1 using the pedestrian information and the vehicle information. Further, the server 6 transmits the danger notification to the terminal 1 having the predetermined priority degree. By narrowing a notification destination to the terminal having the predetermined priority degree among the plurality of terminals, the information can be transmitted to a pedestrian or a driver with high necessity of the notification with less delay (at appropriate time). That is, the notification destination and notification opportunity of the danger notification (one example of a transmission destination and transmission opportunity of the information) are made appropriate.

The pedestrian carrying the terminal 1A that receives the danger notification can recognize a surrounding environment and take a collision avoiding action such as stopping walking or changing a moving direction as needed by the notification. Similarly, the driver of the vehicle V loaded with the terminal 1B that receives the notification can take the collision avoiding action such as a braking operation or a steering operation according to the notification.

### <Configuration Example of Base Station>

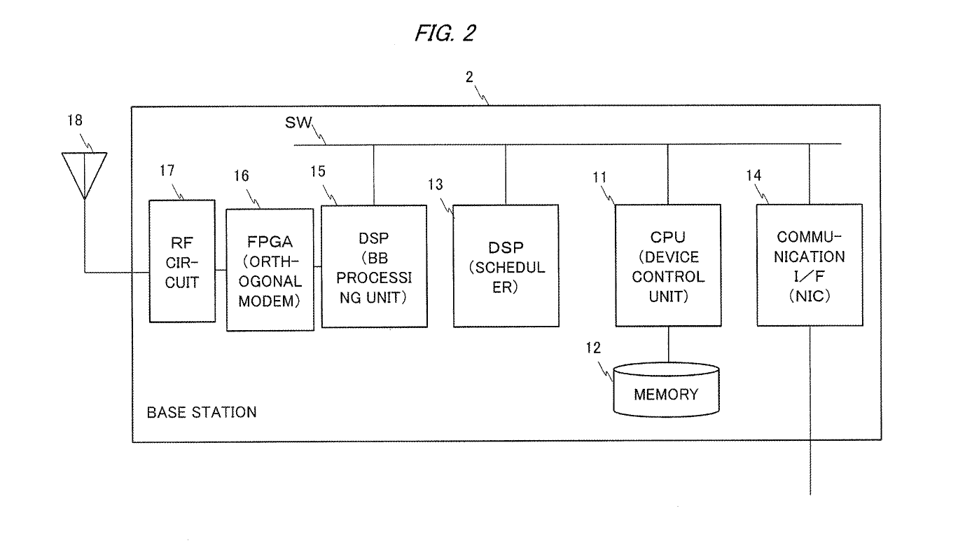

FIG. 2 illustrates a configuration example of the base station 2. The base station 2 includes a Central Processing Unit (CPU) 11, a Digital Signal Processor (DSP) 13, a communication interface (communication I/F) 14, and a DSP 15 connected through an internal switch SW.

In addition, the base station 2 includes a memory 12 connected to the CPU 11, a Field Programmable Gate Array (FPGA) 16 connected to the DSP 15, a Radio Frequency (RF) circuit 17 connected to the FPGA 16, and an antenna 18 connected to the RF circuit 17.

The DSP 13 is operated as a scheduler that performs allocation of a wireless channel (wireless resource) to uplink (UL) and downlink (DL) terminals or the like. The DSP 15 is operated as a BB processing unit that performs digital baseband processing. The FPGA 16 is operated as an orthogonal modem that performs conversion between a baseband signal (BB signal) and an Orthogonal Frequency Division Multiplexing (OFDM) signal.

The DSP 15, the FPGA 16 and the RF circuit 17 perform the following processing regarding a DL direction (base station to terminal). The DSP 15 generates the baseband signal for which data in the DL direction is encoded and modulated, and inputs the signal to the FPGA 16. The FPGA 16 performs orthogonal modulation to the baseband signal. The RF circuit 17 performs digital-analog conversion (DA conversion) of the signal obtained by the orthogonal modulation, conversion to a wireless signal by up-conversion of an analog signal, and amplification of the wireless signal, and makes the wireless signal be emitted from the antenna 18.

In addition, the DSP 15, the FPGA 16 and the RF circuit 17 perform the following processing regarding an UL direction (terminal to base station). The RF circuit 17 performs low noise amplification of the wireless signal received from the antenna 18, down-conversion of the low noise amplified signal, and analog-digital conversion (AD conversion) of the down-converted signal. The signal obtained by the AD conversion is demodulated to the BB signal by the FPGA 16. The DSP 15 demodulates and decodes the BB signal, and obtains the data in the UL direction.

The communication I/F 14 is connected with the SGW 3, the MME (not illustrated in the figure), and the other base stations, and performs transmission/reception processing of the packet. As the communication I/F 14, a network interface card (NIC) is applied for example.

The memory 12 includes a main storage and an auxiliary storage. The main storage is used as an evolution area of a program, a work area of the CPU 11, and a storage area or a buffer area of the data and the program. The main storage is formed by a Random Access Memory (RAM) or a combination of the RAM and a Read Only Memory (ROM).

The auxiliary storage is used as the storage area of the data and the program. The auxiliary storage is formed by a nonvolatile storage medium such as a hard disk drive (HDD), a Solid State Drive (SSD), a flash memory, or an Electrically Erasable Programmable Read-Only Memory (EEPROM). In the auxiliary storage, a removable recording medium such as a disk type storage medium or a USB memory can be included.

The CPU 11 performs various processing by executing the program stored in the memory 12. For example, the CPU 11 performs call processing of the terminal 1, and maintenance and monitoring processing of the base station 2 or the like.

In addition, as the base station 2, a base station formed by an REC (Radio Equipment Control) device and one or more RE (Radio Equipment) devices is applicable. In the case that the base station is formed by the REC device and the RE device, for example, the REC device and the RE device are separated between the DSP 15 and the FPGA 16, and both are connected by a physical link (a metal wire or an optical fiber). On both ends of the physical link, an interface circuit for converting a signal form to a signal form for transmission by the physical link and returning the signal form to an original form is provided. For the interface circuit, for example, a circuit suited to or based on a Common Public Radio Interface (CPRI) is applicable.

### <Configuration Example of Terminal>

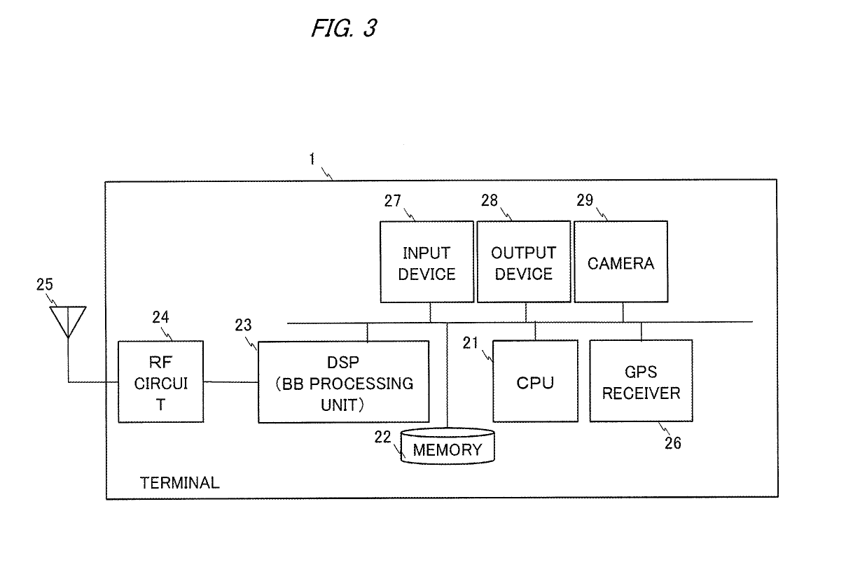

FIG. 3 illustrates a configuration example of the terminal 1 (mobile terminal, in-vehicle terminal). The terminal 1 includes a CPU 21, a memory 22, a DSP 23, a Global Positioning System (GPS) receiver 26, an input device 27, an output device 28, and a camera 29 connected to each other through a bus. An RF circuit 24 is connected to the DSP 23, and an antenna 25 is connected to the RF circuit 24. Note that, in the case of the in-vehicle terminal, for example, speed information, position information and direction information obtained by a speed meter (vehicle speed meter) and a car navigation device (that calculates a position and a direction) can be utilized. The RF circuit 24 is operated as a transmission unit (transmitter) and a reception unit (receiver).

The DSP 23 is operated as a BB processing unit. The DSP 23 performs conversion processing between the data (digital signal) and the baseband signal (BB signal). The RF circuit 24 performs the conversion processing between the BB signal and the wireless signal. The wireless signal is transmitted and received by the antenna 25.

The GPS receiver 26 calculates position coordinates of the terminal 1 by receiving a radio wave from a GPS satellite, and supplies the position coordinates to the CPU 21. The input device 27 is used for inputting the data and the information. The input device 27 is, for example, a key, a button, a pointing device (such as a mouse), a touch panel, a microphone, or the like. The output device 28 is used for outputting the information. The output device 28 is a display, a speaker, a lamp, or the like. A vibrator that vibrates a main body of the terminal 1 is also included in the output device 28. The camera 29 is used for photographing an image and a moving image.

For the memory 22, the one similar to the memory 12 is applicable. The CPU 21 performs the processing as the terminal 1A or the processing as the terminal 1B by loading and executing the program stored in the memory 22. In the memory 22, an application program (called “a terminal application”, hereinafter) that collects and transmits the information (dataset) for determining the danger and the priority degree relating to the embodiment and controls a danger reporting operation performed by the terminal 1 when the danger notification is received is installed. The application program is executed by the CPU 21.

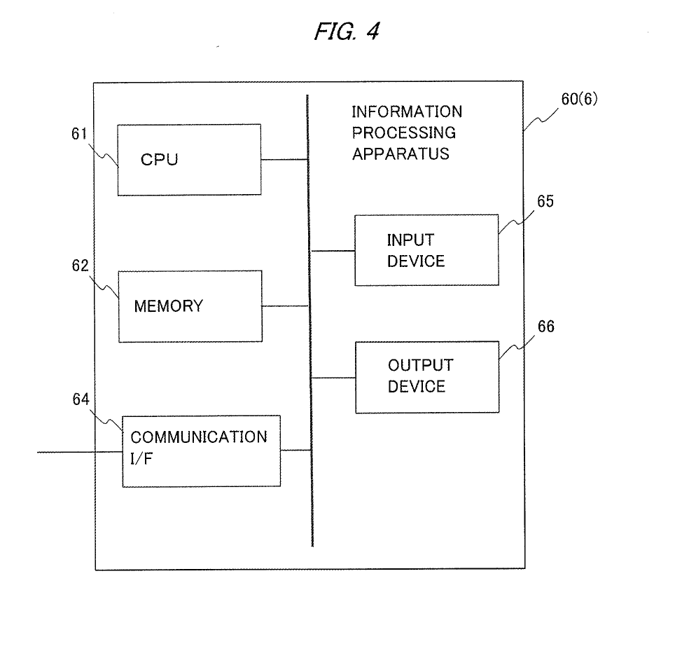

FIG. 4 illustrates a configuration example of an information processing apparatus 60 usable as the server 6 or the like. For the information processing apparatus 60, a dedicated computer like a server machine or a general purpose computer like a personal computer (PC) or a work station (WS) is applicable.

In FIG. 4, the information processing apparatus 60 includes a CPU 61, a memory 62, a communication I/F 64, an input device 65, and an output device 66 connected to each other through a bus. The one same as the memory 12 is applicable as the memory 62. For the communication I/F 64, the one same as the communication I/F 14 is applicable. For the input device 65 and the output device 66, the ones same as the input device 27 and the output device 28 are applicable.

The CPU 61 is operated as “a danger determination unit” that determines the danger and determines the priority degree by loading and executing the program stored in the memory 62. Note that each of the memory 12, the memory 22 and the memory 62 is an example of “a storage (storage device)”, “a storage medium”, “a memory” and “a storage unit”. Each of the CPU 11, the CPU 21 and the CPU 61 is an example of “a control device”, “a control unit”, “a controller”, “a processor” and “a processing unit”.

A CPU is also called as an MPU (Microprocessor) or a processor. The CPU is not limited to a single processor and may be a multiprocessor configuration. In addition, a single CPU connected by a single socket may have a multicore configuration. At least a portion of the processing performed in the CPU may be performed in the processor other than the CPU, for example, in a dedicated processor such as a Digital Signal Processor (DSP), a Graphics Processing Unit (GPU), an arithmetic operation processor, a vector processor or an image processing processor.

Furthermore, at least a portion of the processing performed in the CPU may be performed in an integrated circuit (IC) or the other digital circuits. In addition, the integrated circuit and the digital circuit may include an analog circuit. The integrated circuit includes an LSI, an Application Specific Integrated Circuit (ASIC) and a programmable logic device (PLD). The PLD includes, for example, a Field-Programmable Gate Array (FPGA). At least a portion of the processing performed in the CPU 11 may be executed by the combination of the processor and the integrated circuit. The combination is called, for example, a microcontroller (MCU), an SoC (System-on-a-chip), a system LSI or a chip set or the like.

Note that the information processing apparatus 60 can be used as the information processing apparatus operated as the SGW 3 or the PGW 4. That is, by installing the program for an operation as the SGW 3 or the PGW 4 to the memory 62 and executing the program by the CPU 61, the operation as the SGW 3 or the PGW 4 is performed.

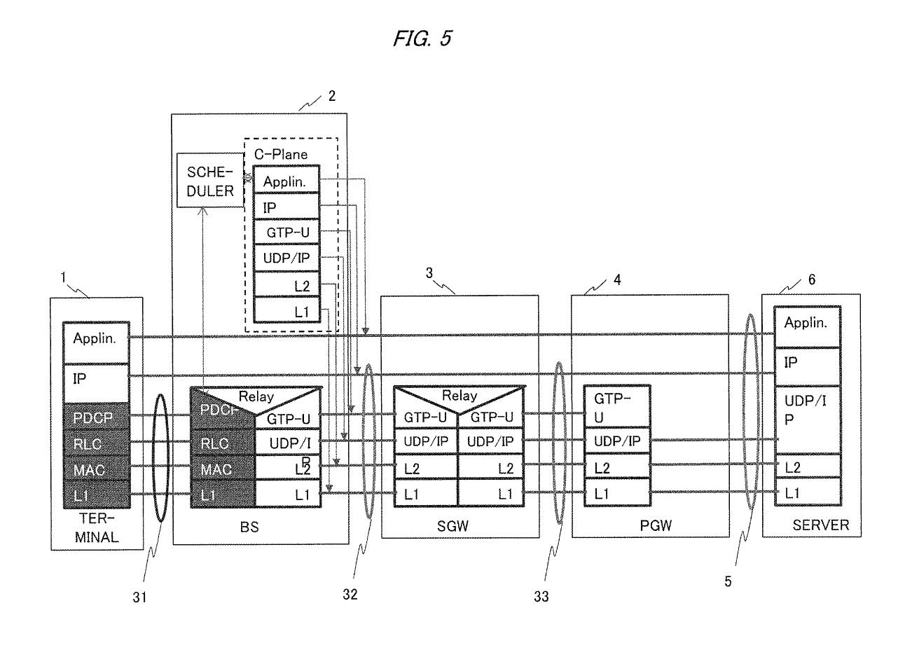

FIG. 5 is an explanatory drawing of a protocol stack of communication relating to the terminal, the base station, the SGW, the PGW and the server. The terminal 1 and the base station 2 are connected by a physical layer (layer 1 (L1)) and a layer 2 (L2) forming a wireless link 31. The layer 2 is formed of a Media Access Control (MAC) layer, a Radio Link Control (RLC) layer, and a Packet Data Convergence Protocol (PDCP) layer. A protocol of a layer 3 or more includes an IP (Internet Protocol) layer and an application layer.

In the base station 2, the signal (wireless signal) based on the L1, the MAC, the RLC and the PDCP is converted to the packet of the L1 (layer 1), the L2 (layer 2), and UDP (User Datagram Protocol)/IP by protocol conversion, a GTP-U header is imparted further, and the signal is transferred through a tunnel 32 (the bearer between the base station 2 and the SGW 3). In the SGW 3, the packet is transferred to the bearer (a tunnel 33 of GTP-U) between the SGW 3 and the PGW 4, and sent to the PGW 4. In the PGW 4, the packet from which the GTP-U header is removed is transferred through the IP network 5 to the server 6.

In FIG. 5, mainly the protocol stack of a user plane (U plane) transmitting user data (packet) is illustrated. In the base station 2 in FIG. 5, it is illustrated that the data (control signal) of a control plane (C plane) can be inserted to the respective layers.

The bearer (called “a dedicated bearer”) other than a normal bearer is established between the terminal 1 and the PGW 4, and the packet of a specific flow can be transmitted using the dedicated bearer. While a band is shared between flows in the normal bearer, the specific flow can occupy the band in the dedicated bearer. Therefore, the packet for the terminal 1 to send the position information or the like (dataset) to the server 6 and the packet for the server 6 to send the danger notification to each terminal 1 are transmitted using the dedicated bearer. Thus, the communication between the terminal 1 and the server 6 can be performed at a more stable speed than the speed in the case of using the normal bearer.

For example, in the case that the MME recognizes that the terminal 1 originates a call to the server 6, establishment of the dedicated bearer is instructed to the SGW 3 and the PGW 4, and the terminal 1 and the PGW 4 are instructed such that the packet relating to the dataset and the danger notification is transmitted by the dedicated bearer.

### <Processing in Server>

The server 6 is operated as a device including the danger determination unit, and determines the necessity of the danger notification from the information (position, moving direction, speed) of the vehicle. In addition, the server 6 sets the priority degree of the danger notification to each terminal 1 based on the position information of each terminal 1. The priority degree is derived from the position of the vehicle and the position of the pedestrian. As one example, the priority degree can be set as follows.

(Example) In the case that there is a person (pedestrian) inside an intersection

Priority degree “1”: the vehicle approaching the intersection without lowering the speed
An accident is avoided when the driver of the vehicle notices the person.
   Priority degree “2”: the pedestrian using a terminal (monitored by clicks, a camera or the like)
It is possible that the pedestrian does not notice the vehicle and an avoiding action can be taken by recognizing the vehicle.
   Priority degree “3”: an aged person, a child, a disabled person Priority degree “4”: a healthy person

Further, the server 6 changes a cycle of collecting the dataset (to be described later) including the position information from the plurality of terminals 1 according to the priority degree.

In the embodiment 1, an example that the terminal 1 performs the communication in the application layer with the server 6 and the server 6 is operated as the device including the danger determination unit will be described. The server 6 collects the information of the plurality of terminals 1 (the mobile terminal 1A and the in-vehicle terminal 1B) existing in a single or a plurality of areas.

In the present embodiment, in order to simplify the description, one area is managed by the server 6, and the plurality of terminals 1 existing in the one area are managed. The area is included in a coverage area of a cell formed by the base station 2, and the terminal 1 can communicate with the base station 2 anywhere within the area.

In addition, in the present embodiment, an example that one intersection where a traffic light is installed is included in the area (each intersection forms an area) will be described. However, an installation location of the traffic light does not need to be always the intersection. That is, the priority degree “1” may be set to the vehicle approaching a pedestrian crossing without lowering the speed. In short, the priority degree “1” is set to the terminal 1 loaded in the vehicle approaching a predetermined spot (intersection, pedestrian crossing) without the speed reduction. In addition, it is not a prerequisite that the area includes the intersection or the traffic light.

In the memory 62 of the server 6 (the information processing apparatus 60 operated as the server 6), the information indicating a geographic range of the area is stored beforehand. The terminal 1 transmits the data (called the dataset) including the position information of the terminal 1 to the server 6. The server 6 (CPU 61) associates the position information in the dataset and the area, and stores each dataset in the memory 62. That is, the dataset of the terminal 1 existing inside the area is associated with the area and stored. To the dataset, collection time (time stamp) is set. The information of the area includes the position information of the intersection and the traffic light described above.

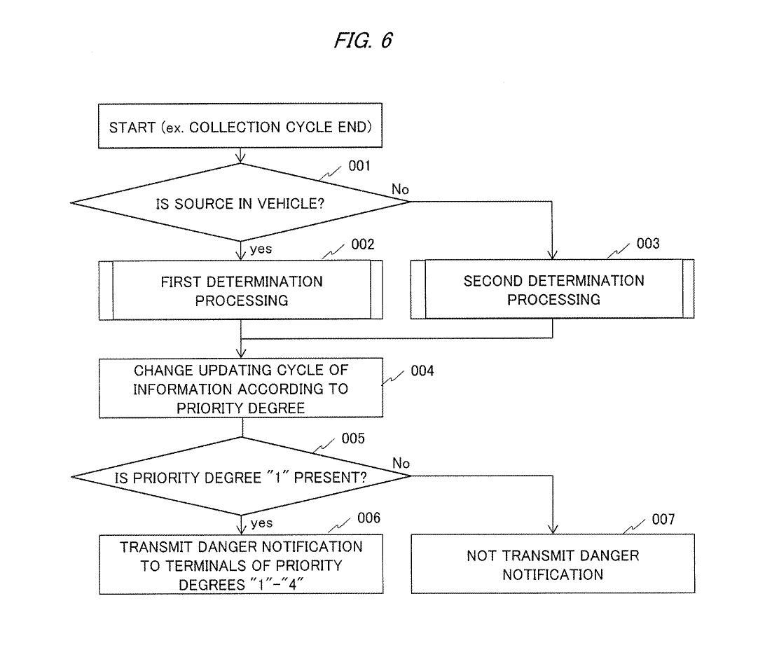

FIG. 6 is a flowchart illustrating one example of the processing executed by the server 6. The processing in FIG. 6 is executed by the CPU 61 of the server 6 (the information processing apparatus 60 operated as the server 6), for example. The processing illustrated in FIG. 6 is started in the case that the cycle of collecting the dataset (the vehicle information, the pedestrian information) including the position information from the terminal 1 by the server 6 ends. For example, the server 6 transmits a dataset transmission request to each terminal 1 matched with the cycle, sets a timer that times the cycle, and waits for the dataset arriving from each terminal 1 until the end of the cycle (timer).

In 001, one of the collected datasets transmitted from each terminal 1 is extracted, and whether or not the terminal 1 which is a source of the dataset is loaded in the vehicle is determined. The processing advances to 002 when it is determined that the terminal is loaded in the vehicle, and the processing advances to 003 otherwise (when the terminal 1 which is the source is carried by the pedestrian). Being loaded in the vehicle includes the case that the terminal 1 is loaded in the vehicle (the case of an in-vehicle dedicated terminal) and the case that the mobile terminal A is carried into the vehicle.

In the processing of 001, determination is made based on an identifier (flag) indicating whether or not the terminal is loaded in the vehicle, included in the dataset, for example. For the case that the terminal 1 is the in-vehicle terminal 1B and the mobile terminal 1A carried into the vehicle, the identifier indicating “in-vehicle” is included in the dataset. Thus, the in-vehicle mobile terminal 1A is handled as the in-vehicle terminal.

In 002, the CPU 61 performs first determination processing. The first determination processing is the processing of determining the priority degree of the terminal 1 loaded in the vehicle. In 003, the CPU 61 performs second determination processing. The second determination processing is the processing of determining the priority degree of the terminal 1 carried by the pedestrian.

In 004, the CPU 61 changes the cycle of updating the information (dataset) of the terminal 1 according to the priority degree of the terminal 1 determined by the processing of 002 and 003. For example, the cycle is a dataset collection cycle (interval). For example, a plurality of cycle lengths corresponding to the plurality of priority degrees are prepared. The higher the priority order is, the shorter the cycle length becomes. In the present embodiment, in order to simplify the description, one cycle is set for one area, and the cycle length corresponding to the highest priority degree among the priority degrees set to the terminals 1 existing in the area is applied.

In 005, the CPU 61 determines whether or not there is the terminal 1 having the priority degree “1” in the terminals 1 associated with the area. The processing advances to 006 when it is determined that there is the terminal 1 of the priority degree “1”, and the processing advances to 007 otherwise.

In 006, the CPU 61 performs the processing of transmitting the danger notification to the respective terminals 1 having each of the priority degree “1” to the priority degree “4” associated with the area where the terminal 1 of the priority degree “1” exists. In 007, the danger notification is not transmitted (the processing is not performed in particular).

In this way, in the first determination processing, in the case that the terminal 1 having the priority degree of the predetermined priority order (priority degree “1”) or higher exists in the plurality of terminals 1, the CPU 61 (one example of the processing unit) determines to transmit the danger notification (determines that the transmission of the danger notification is needed).

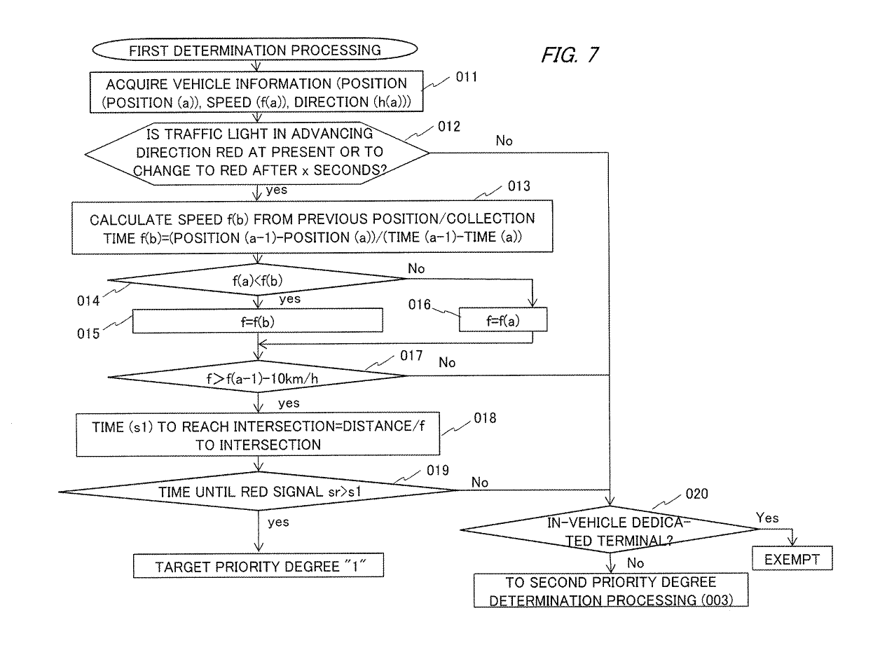

FIG. 7 is a flowchart illustrating one example of the first determination processing. In the processing of 011, the CPU 61 acquires the vehicle information included in the dataset from the “in-vehicle” terminal 1. The vehicle information includes the position information (position (a)), the speed information (speed f(a)), and the direction information (h(a)).

In the processing of 012, the CPU 61 determines whether the traffic light of the intersection present in the advancing direction is red at present or is to change to red after x seconds. For example, the CPU 61 specifies the traffic light that is installed at the intersection that the vehicle is to enter next and coincides with the advancing direction of the vehicle (that the vehicle follows next), based on the information of the area stored in the memory 62 and the position and direction information of the vehicle.

Further, the CPU 61 makes the determination of 012 using the information indicating the time of red of the specified traffic light (for example, stored beforehand in the memory 62, however, may be cyclically collected). Note that a value of x is appropriately changeable according to the collection cycle of the dataset or the like. The processing advances to 013 when it is determined that the traffic light is red at present or is to change to red after x seconds, and the processing advances to 020 otherwise.

In the processing of 013, the CPU 61 calculates a speed f(b) from the position and the collection time of a previous time. In the processing of 014, the CPU 61 determines whether or not the speed f(b) is greater than the speed f(a). The CPU 61 sets the value of f(b) to the value of the speed f (015) when it is determined that the speed f(b) is greater, and the CPU 61 sets the value of f(a) to the value of the speed f (016) when it is determined that the speed f(a) is greater.

In the processing of 017, the CPU 61 determines whether or not the value of the speed f is larger than the value of the previous speed f(a−1)−10 km/h. The processing advances to 018 when it is determined that the value of the speed f is larger, and the processing advances to 020 otherwise. “10 km/h” is an example and it can be appropriately changed. The processing of 017 is the processing for excluding the vehicle, the speed of which is lowered (decelerated) from the previous time by a fixed value or more, from targets of the danger notification.

In the processing of 018, the CPU 61 obtains time s1 until reaching the intersection. The value of s1 is obtained by “s1=a distance to the intersection/f” for example. In the processing of 019, the CPU 61 determines whether or not time sr until a red signal is larger than the value of s1. When it is determined that it is sr>s1, the source of the dataset is determined as the target of the danger notification, and the priority degree “1” is set. When it is determined that it is not sr>s1, the processing advances to 020.

In 020, the CPU 61 determines whether or not the terminal 1 which is the source of the dataset is the in-vehicle dedicated terminal. When it is determined that it is the in-vehicle dedicated terminal, the terminal 1 which is the source of the dataset is determined to be exempt from the notification. When it is determined that it is not the in-vehicle dedicated terminal, the processing advances to second priority degree determination processing. The processing of 020 is performed to avoid the determination of the mobile terminal 1A handled as the in-vehicle terminal as being exempt from the danger notification. The processing of 020 can be performed depending on whether or not the information (for example, a terminal ID, a flag or the like) capable of identifying the terminal loaded in the vehicle is set to the dataset, for example.

In this way, in the first determination processing, when it is determined that the vehicle loaded with the in-vehicle terminal 1 is approaching the intersection (one example of “predetermined spot”) without the speed reduction, the CPU 61 sets the priority degree “1” (one example of the predetermined priority degree) to the in-vehicle terminal 1.

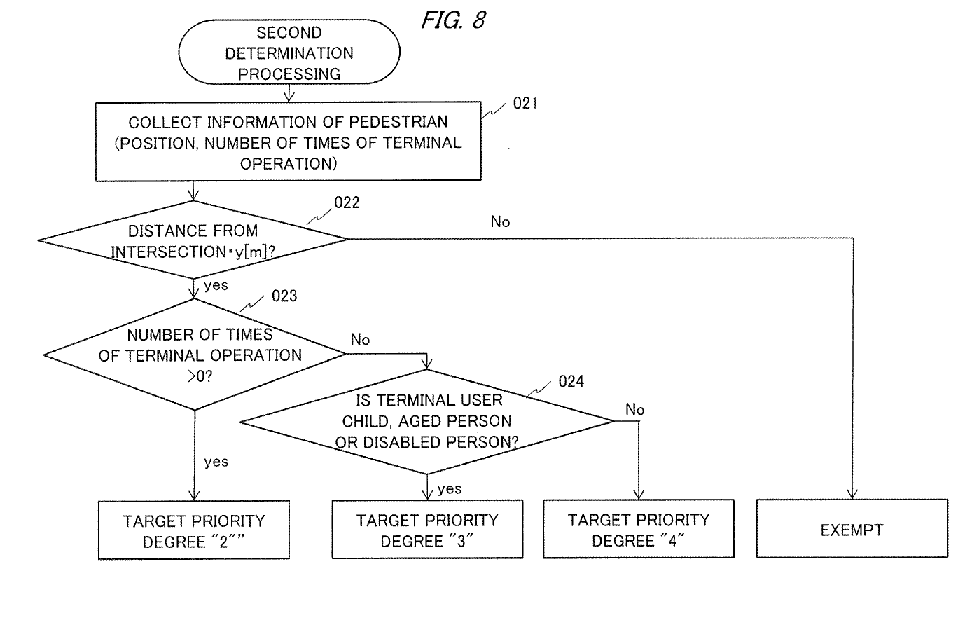

FIG. 8 is a flowchart illustrating one example of the second determination processing. In 021, the CPU 61 acquires the information (the position information, the number of times of the operation of the terminal 1) of the pedestrian included in the dataset. In 022, the CPU 61 determines whether or not a distance from the intersection to the position of the terminal (pedestrian) is within a predetermined threshold (y[m]).

The value of a threshold y can be appropriately set. For example, the threshold y that covers a range within the intersection (within the roadway) from a center of the intersection is set. When it is determined that the distance exceeds the threshold y, it is determined that the terminal 1 (pedestrian) is exempt from the danger notification. In the case that the distance is equal to or shorter than the threshold y, the processing advances to 023.

However, since an area determined to be within the intersection does not need to be circular (a circle, a radius of which is the threshold y(m)), the area in an appropriate shape may be set, and in the processing of 022, whether or not the pedestrian is positioned within the set area may be determined.

In 023, the CPU 61 determines whether or not the number of times of the operation of the terminal 1 is larger than zero. In the case that the number of times of the operation is larger than zero, the terminal 1 (pedestrian) is determined as a transmission target of the danger notification, and the priority degree “2” is set. In the case that the number of times of the operation is not larger than zero, the processing advances to 024.

The terminal 1 to which the priority degree “2” is set includes the terminal 1 in use (the terminal 1, a screen of which is being looked into by a user). In this way, the priority degree higher than that of the terminal in a non-use state is set to the terminal 1, the distance of which from the intersection is y or shorter, and the terminal in use (positioned in a predetermined range from the predetermined spot).

In 024, whether the user (pedestrian) of the terminal 1 which is the source of the dataset is one of a child, an aged person and a disabled person is determined. For example, the determination of 024 can be made depending on whether the information indicating that the user of the terminal 1 is one of the child, the aged person and the disabled person is included in the dataset.

As an alternative configuration, the server 6 may access a computer of a registered organization of the child, the aged person and the disabled person and the determination of 024 may be made based on an answer to whether or not the identifier of the terminal 1 is linked with the child, the aged person or the disabled person. In this case, the information indicating that the user is one of the child, the aged person and the disabled person may be absent in the dataset.

The terminal 1 (pedestrian) is determined as the transmission target of the danger notification and the priority degree “3” is set to the terminal 1 in the case that the user is one of the child, the aged person and the disabled person, and the terminal 1 (pedestrian) is determined as the transmission target of the danger notification and the priority degree “4” is set otherwise.

Note that, in the present embodiment, there are four priority degrees “1”, “2”, “3” and “4”, and the priority order is higher when the number is smaller. The child is a boy or a girl under a predetermined age (for example, 12 years old), for example. The aged person is a male or a female of a predetermined age (for example, 65 years old) or older. However, the age can be appropriately set. An evaluation standard for the disabled person can be appropriately set.

In the processing by the server 6 described above, in the case that there is a person within the intersection and it is highly possible that the vehicle is to enter the intersection at a predetermined speed, the danger notification is transmitted to the terminal 1 having one of the priority degrees “1”-“4”. The carrier of the terminal 1 can take a danger avoiding action based on the danger notification. On the other hand, to the terminal 1, the distance of which from the intersection is larger than the threshold y even though it exists in the area, (the pedestrian not present on a roadway), the danger notification is not transmitted. In this way, the transmission target of the danger notification is narrowed to the terminal 1 having the predetermined priority degree among the terminals 1 existing in the area. Therefore, loads and time relating to the transmission of the danger notification can be reduced or shortened.

### <Processing Example of Terminal>

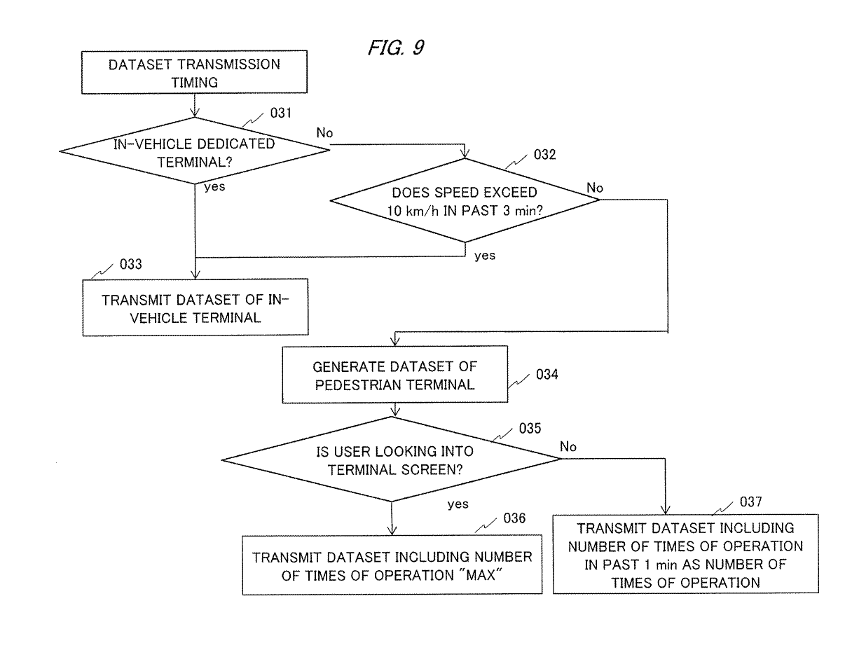

FIG. 9 is a flowchart illustrating a processing example in the terminal 1. The processing in FIG. 9 is performed by executing the terminal application by the CPU 21 of the terminal 1 for example. The processing in FIG. 9 is started at dataset transmission timing. The transmission timing may be cyclically generated or may be generated by a request from the server 6 or the like.

In 031, the CPU 21 determines whether or not the terminal 1 is the in-vehicle terminal 1B (in-vehicle dedicated terminal). For example, configuration information indicating whether or not it is the in-vehicle terminal 1B is stored beforehand in the memory 22, and the CPU 21 refers to the configuration information and makes the determination.

In 032, the CPU 21 determines whether or not the speed in the predetermined time (for example, three minutes) going back to the past from the present exceeds the predetermined speed (10 km/h). The processing advances to 033 when it is determined that the speed exceeds the predetermined speed, and the processing advances to 034 otherwise. The speed can be calculated from a history of the position information obtained using the GPS receiver 26 for example.

The processing of 032 is the processing for determining whether the terminal 1 is the mobile terminal 1A (the terminal other than the in-vehicle dedicated terminal) loaded in the vehicle or carried into the vehicle. Note that, as long as whether the terminal 1 is the terminal other than the in-vehicle dedicated terminal present in the vehicle can be determined, a length of the predetermined time and the predetermined speed can be appropriately set.

In 033, the CPU 21 performs the processing of generating the dataset transmitted by the in-vehicle terminal and transmitting it to a predetermined destination (server 6). The dataset includes the identifier (flag) indicating that it is the in-vehicle terminal, and the position information, the speed information and the direction information of the terminal 1 or the like. The position information and the information of the advancing direction are acquired from an in-vehicle car navigation device for example. The speed is acquired from an in-vehicle vehicle speed meter for example. However, a route of obtaining the position, the speed and the direction is not limited to the above description. The dataset may further include the information capable of identifying whether it is the in-vehicle dedicated terminal like the terminal ID or the like.

In 034, the CPU 21 performs generation and transmission processing of the dataset of a pedestrian terminal. The pedestrian terminal includes the mobile terminal 1A carried by the pedestrian. The dataset includes the identifier (flag) indicating that it is the in-vehicle terminal, and the position information of the terminal 1 or the like. The position information can be obtained using the GPS receiver 26. However, the route of obtaining the position information is not limited to the above description. The dataset may further include the information capable of identifying whether it is the in-vehicle dedicated terminal like the terminal ID or the flag or the like.

In 035, whether or not the user of the terminal 1 is using the terminal 1 is determined. That is, when the user is using the terminal 1, it is conceivable that the user of the terminal 1 is looking into the screen. Therefore, the CPU 21 determines whether or not the user of the terminal 1 is looking into the screen of the terminal 1.

In the processing of 035, the CPU 21 performs face recognition of an image photographed by the camera 29 for example, and in the case that a face is recognized, it can be determined that the user is looking into the screen. A view angle (visual field range) of the camera 29 is set at a position where the face of the user looking into the screen of the terminal 1 is photographed.

The processing advances to 036 when it is determined that the user is looking into the screen in the processing of 035, and the processing advances to 037 otherwise. In the processing of 036, the CPU 21 performs the transmission processing of the dataset including the number of times of the operation “MAX (a maximum value of settable values for the number of times of the operation)”. In the processing of 037, the CPU 21 performs the transmission processing of the dataset including the number of times of the operation within the time (for example, one second) going back for the predetermined time from the present.

The operation includes depression of the key or the button, a mouse click, a tap to the touch panel, double tap, drag, slide, flick and swipe or the like. What kind of operation is to be counted as one time can be appropriately set. As described above, the dataset is transmitted from the terminal 1 and is communicated to the server 6.

Next, using FIG. 3, the operation of the terminal 1 that receives the danger notification will be described. The terminal 1 that receives the danger notification reports the danger, alerts the driver of the vehicle loaded with the terminal 1 and the pedestrian carrying the terminal 1, and promotes the danger avoiding action.

In the case that the terminal 1 is the in-vehicle terminal 1B, for example, through the car navigation device, alarm sound or voice guidance is outputted and the information notifying the danger is displayed on the screen. In the case that the terminal 1 is the mobile terminal 1A, the information notifying the danger is displayed on a display included in the output device 28, the alarm sound or the voice guidance is outputted from a speaker, and a vibration using a vibrator not illustrated in the figure is performed.

A reporting method can be changed according to a utilization situation of the user of the mobile terminal 1A. For example, the user is photographed by the camera 29, and when it can be determined that the user is looking into the screen from a result of image analysis (the face recognition or the like), a screen for alerting can be displayed or volume of sound output can be turned up.

In addition, a configuration of storing an operation history of the user in the memory 22 is adopted, and when the danger notification is received, in the case that a frequency of the operation in the range going back for the predetermined time from the point of time exceeds a threshold, the screen for alerting can be displayed and the volume of the sound output can be turned up. In the case that the terminal 1 is not utilized, it is conceivable to report the danger by the sound output and vibrations. Note that, in the embodiment 1, an example of transmitting the notification to the terminals 1 of the priority degrees “1”-“4” is described, however, the range of the terminals 1 to transmit the notification may be narrowed to the priority degree “3” and higher according to the number of the terminals 1 as the notification targets.

### Embodiment 2

Next, the embodiment 2 will be described. Since the embodiment 2 includes common points with the embodiment 1, differences will be mainly described and the description is omitted for the common points. In the embodiment 2, an example of notifying the danger other than a collision with a vehicle will be described.

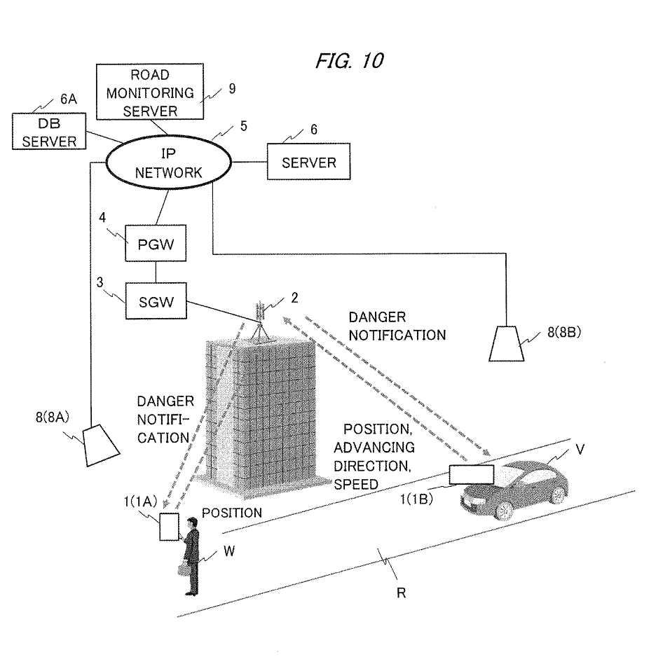

In the embodiment 2, the danger notification based on an analysis result of the image in a road monitoring system is performed. FIG. 10 is a diagram illustrating one example of the danger notification system relating to the embodiment 2. As the difference from the embodiment 1, the road monitoring system as follows is provided. The road monitoring system includes one or more cameras 8. In the example in FIG. 10, a camera 8A and a camera 8B are illustrated. The camera 8 photographs the vehicle V traveling on the roadway R, and the pedestrian W crossing the roadway R. The image (moving image) photographed by the camera 8 is communicated through the IP network 5 to a road monitoring server 9.

As the road monitoring server 9, the information processing apparatus 60 illustrated in FIG. 4 is applicable. In the memory 62 of the road monitoring server 9, various programs including the program that analyzes the image and the moving image photographed by the camera 8 and the program that determines the necessity of the danger notification based on the analysis result, and the data used when executing the program are stored. The road monitoring server 9 detects the vehicle entering the intersection and the pedestrian crossing the pedestrian crossing of the intersection or the like by the analysis of the image (moving image) photographed by the camera 8, and determines whether a demand for the danger notification is needed.

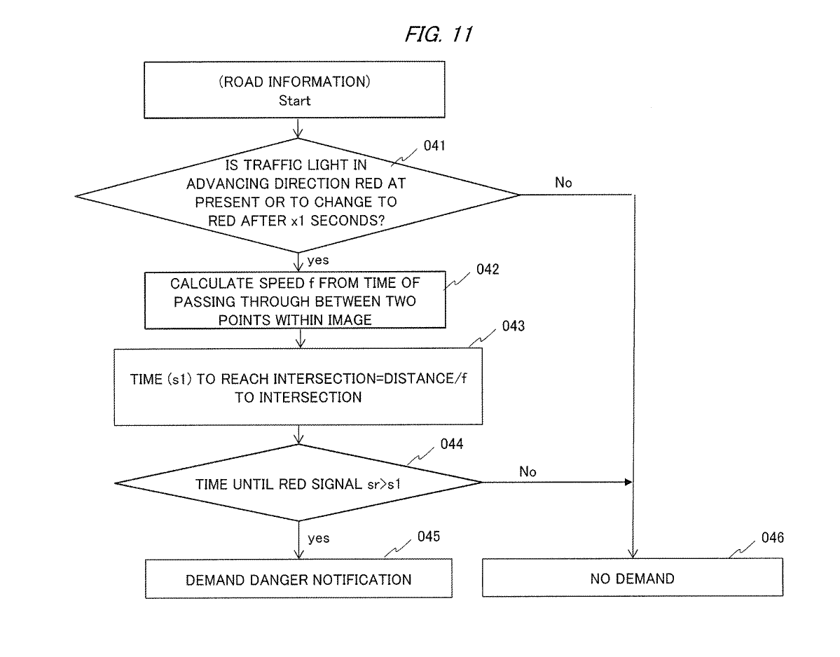

FIG. 11 is a flowchart illustrating one example of the necessity determination of the danger notification based on road information. The processing in FIG. 11 is performed by the CPU 61 of the information processing apparatus 60 operated as the road monitoring server 9. As a presupposition of the processing in FIG. 11, it is assumed that the vehicle traveling toward the intersection is detected by the analysis of the moving image photographed from a fixed view point of the camera 8.

In the processing of 041, the CPU 61 determines whether or not the traffic light in the advancing direction of the vehicle is red at present or is to change to red after the predetermined period (for example, ×1 seconds). As a determination method of 041, the determination method of 012 illustrated in FIG. 7 is applicable. The processing advances to 041 when it is determined that the traffic light is red at present or is to change to red after ×1 seconds, and the processing advances to 042 otherwise.

In the processing of 042, the CPU 61 calculates the speed f based on the time in which the vehicle passes between two points within the image. The processing of 043 and 044 is the same as the processing of 018 and 019 illustrated in FIG. 7, so that the description is omitted. The processing advances to 045 when it is determined that it is sr>s1 in the result of the processing of 044, and the processing advances to 046 when it is determined that it is not sr>s1.

In 045, the CPU 21 (road monitoring server 9) transmits a message demanding the danger notification (a transmission request for the danger notification) to the server 6. The message arrives at the server 6 through the IP network 5. In 046, the danger notification is not demanded (the specific processing is not performed).

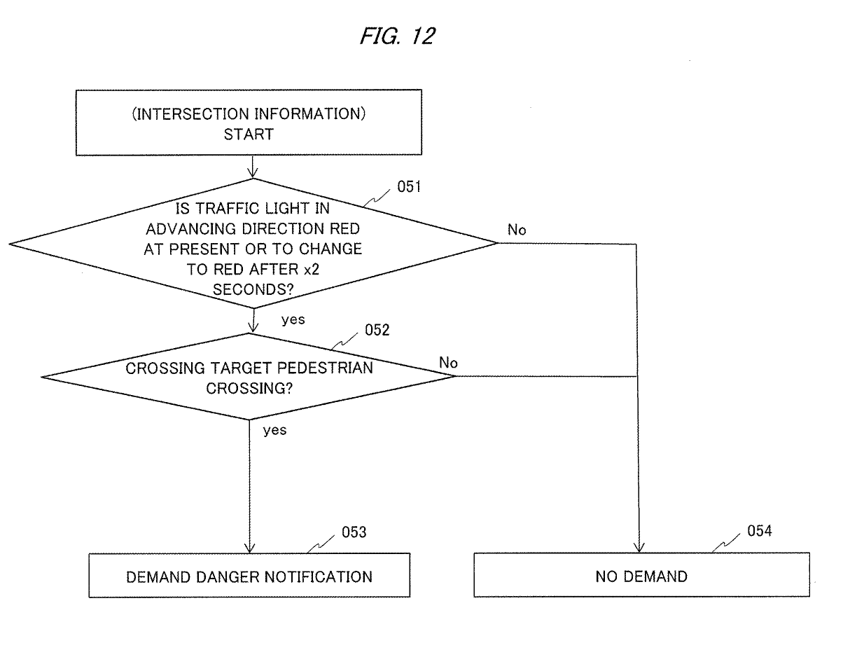

FIG. 12 is a flowchart illustrating one example of the necessity determination of the danger notification based on intersection information (included in the road information). The processing in FIG. 12 is performed by the CPU 61 of the information processing apparatus 60 operated as the road monitoring server 9. As a presupposition of the processing in FIG. 12, it is assumed that the vehicle traveling toward the intersection is detected by the analysis of the moving image photographed by the camera 8.

In the processing of 051, the CPU 61 determines whether or not the traffic light in the advancing direction of the vehicle is red at present or is to change to red after the predetermined period (for example, ×2 seconds). As the determination method of 051, the determination method of 012 illustrated in FIG. 7 is applicable. The processing advances to 052 when it is determined that the traffic light is red at present or is to change to red after ×2 seconds, and the processing advances to 054 otherwise.

In the processing of 052, the CPU 61 determines whether or not there is a person crossing a walkable pedestrian crossing (called a target pedestrian crossing) when the traffic light is red by the image analysis. The processing advances to 053 when it is determined that there is the crossing person, and the processing advances to 054 otherwise.

In 053, the CPU 21 (road monitoring server 9) transmits the message demanding the danger notification (the transmission request for the danger notification) to the server 6. The message arrives at the server 6 through the IP network 5. In 054, the danger notification is not demanded (the specific processing is not performed).

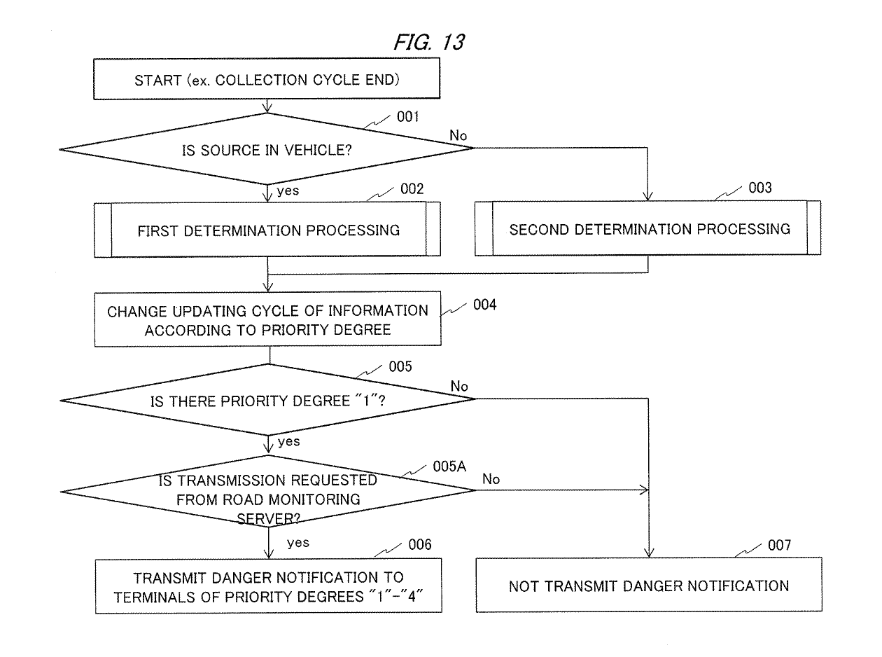

FIG. 13 is a flowchart illustrating a processing example of the server 6 in the embodiment 2. A difference from the embodiment 1 (FIG. 6) is a point that the determination processing of 005A is inserted between 005 and 006.

In 005A, the CPU 61 of the server 6 determines whether or not a transmission request for the danger notification from the road monitoring server 9 has arrived. The processing advances to 006 when it is determined that there is a transmission request, and the processing advances to 007 otherwise.

In this way, in the embodiment 2, the danger notification is transmitted also in the case that there is a demand from the road monitoring server 9 (road management system), in addition to the case that there is the terminal 1 having the priority degree “1”. Note that, for time savings, the transmission of the danger notification based on the demand may be performed by interruption.

<Danger Notification for Something Other than Vehicle>
<<Danger from the Rear>>

To the terminal 1 of the pedestrian, it is possible to transmit the danger notification even for the danger of something other than the vehicle. For example, it is conceivable to notify a single pedestrian of the danger (a snatcher or the like) approaching from the rear.

In the system configuration in FIG. 10, the server 6 receives the image (moving image) photographed by the camera 8. The CPU 61 can analyze the image by the execution of the program stored in the memory 62. In the dataset transmitted by the terminal 1, the information indicating that it is the single pedestrian can be included.

In the embodiment 2, as one example, the necessity of the notification of the danger at the rear is determined depending on whether the following condition 1 and condition 2 are satisfied.

(Condition 1) The number of persons within the predetermined range (example: the radius is 100 m, however, the length of the radius can be appropriately set) centering around the single pedestrian is a predetermined number or smaller. The predetermined range may be circular or fan-shaped.

(Condition 2) There is a person advancing in the same direction as the single pedestrian at the speed higher than the speed of the single pedestrian at the rear of the single pedestrian. The speed can be calculated from a position difference (distance) and a time difference for two times of the datasets for example.

In the case that the condition 1 and the condition 2 are satisfied, the person detected in the condition 2 is determined as a dangerous person (a snatcher or the like). The dangerous person is one example of “predetermined person”.

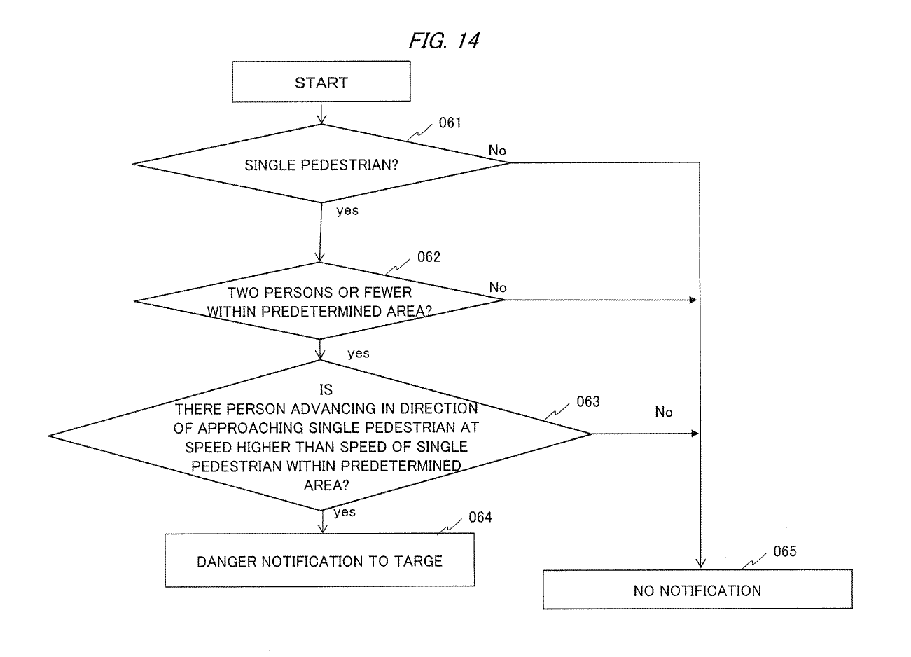

FIG. 14 is a flowchart illustrating a processing example relating to the notification of the danger from the rear. In the processing of 061, the CPU 61 determines whether or not the carrier of the source terminal of the dataset is the single pedestrian. The determination is made depending on whether or not the information indicating that it is the single pedestrian is included in the dataset. The processing advances to 062 when it is determined that it is the single pedestrian, and the processing advances to 065 otherwise.

In the processing of 062, the CPU 61 specifies the single pedestrian in the image by mapping the position information of the terminal 1 in the dataset in the image. The CPU 61 determines whether or not the number of persons present within the predetermined area with the single pedestrian as a reference is the predetermined number (two, for example) or smaller, through the image analysis. The predetermined area is a fan shape with the radius of 100 m extending to the rear of the single pedestrian for example, and a center angle is about 15 to 30 degrees for example though it can be appropriately set. The predetermined area may be a belt-like shape extending to the rear of the single pedestrian. The length in a stretching direction (rear) of a belt shape and a width length can be appropriately set. The processing advances to 063 when it is determined that the number of persons within the predetermined area is the predetermined number or smaller, and the processing advances to 065 otherwise.

In the processing of 063, the CPU 61 determines whether or not there is a person advancing in the direction of approaching the single pedestrian at the speed higher than the speed of the single pedestrian within the predetermined area. The speed can be calculated by the method described above. In addition, for the approaching direction or not, it can be determined as the approaching direction in the case that an angle formed by the advancing direction of each person and the advancing direction of the single pedestrian is within a predetermined range.

In 064, the CPU 61 performs the processing of transmitting the danger notification to the target (pedestrian). In 065, the notification is not performed (the specific processing is not performed). In this way, the notification that calls attention to the danger can be sent to the terminal 1.

### <<Alert Against Dangerous Person>>

In the case that the dangerous person (for example, a gun owner or a sexual offender or the like) is positioned in the predetermined range from the position of the terminal 1, the position information is notified from the server 6. For example, a database server (DB server: management center) 6A that manages the position information of the dangerous person such as the gun owner or the sexual offender in association with the identification information of the terminal carried by the dangerous person is connected to the IP network 5 (see FIG. 10).

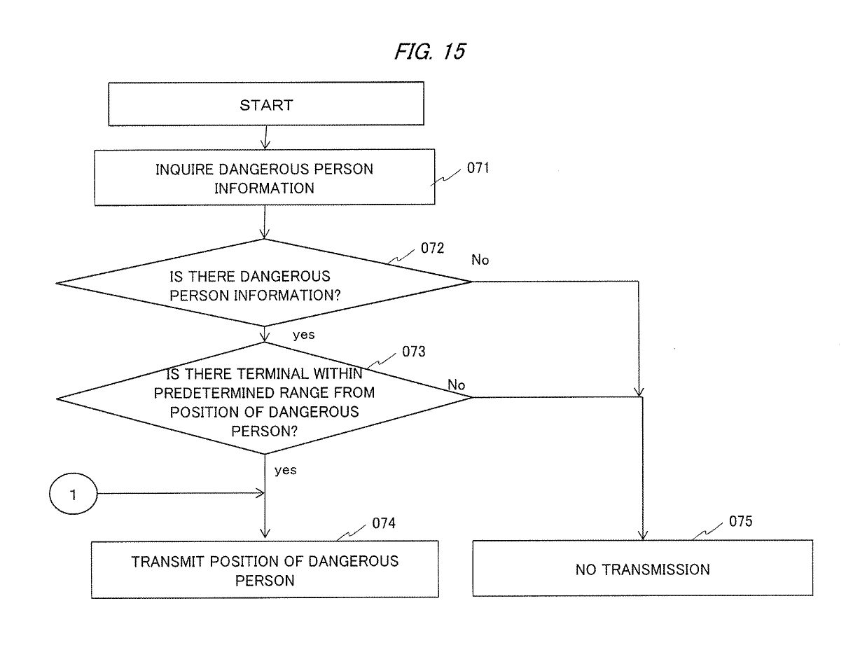

FIG. 15 is a flowchart illustrating a processing example relating to the notification of the position of the dangerous person. The processing in FIG. 15 may be cyclically executed or started with predetermined event occurrence as a trigger. In 071, the CPU 61 sends the identification information (included in the dataset) of the plurality of terminals 1 obtained by collection to the DB server 6A, and inquires of the DB server 6A the information of the dangerous person present in the area.

In 072, the CPU 61 determines whether or not the dangerous person information is returned from the DB server 6A. The processing advances to 073 when it is determined that the dangerous person information is returned, and the processing advances to 075 otherwise. The dangerous person information includes at least the identification information (sent from the server 6) of the corresponding terminal 1. The dangerous person information may further include the information indicating a kind (the gun owner or the sexual offender or the like) of the dangerous person.

In 073, The CPU 61 determines whether the position of the terminal 1 other than the terminal 1 of the dangerous person belongs within the predetermined range (for example, within a circle of a radius r centering around the position of the terminal) from the position information in the dataset received from the terminal 1 of the dangerous person, which is specified from the identification information of the terminal 1 of the dangerous person.

For the value of the radius r, an appropriate value can be set. For example, it is R=500 m, however, it may be larger or smaller. The processing advances to 074 when it is determined that the position of the terminal 1 belongs within the predetermined range, and the processing advances to 075 otherwise.

In 074, the CPU 61 performs the processing of transmitting the position information of the dangerous person to the terminal 1 present within the predetermined range described above (excluding the terminal 1 of the dangerous person). In the case that a type (attribute) of the dangerous person is included in the dangerous person information, the type may be transmitted together with the position information. In 075, the processing of transmitting the position information of the dangerous person is not performed (the specific processing is not performed).

In the processing in FIG. 15, in the case that the position information of the terminal 1 (one example of a first terminal) carried by the dangerous person is received, the CPU performs the processing of transmitting the danger notification to the one or more terminals 1 positioned in the predetermined range from the position of the terminal 1 of the dangerous person. By the processing in FIG. 15, it can be communicated to the user of the terminal 1 that the dangerous person (the gun owner or the sexual offender) is present at the position specified by the position information.

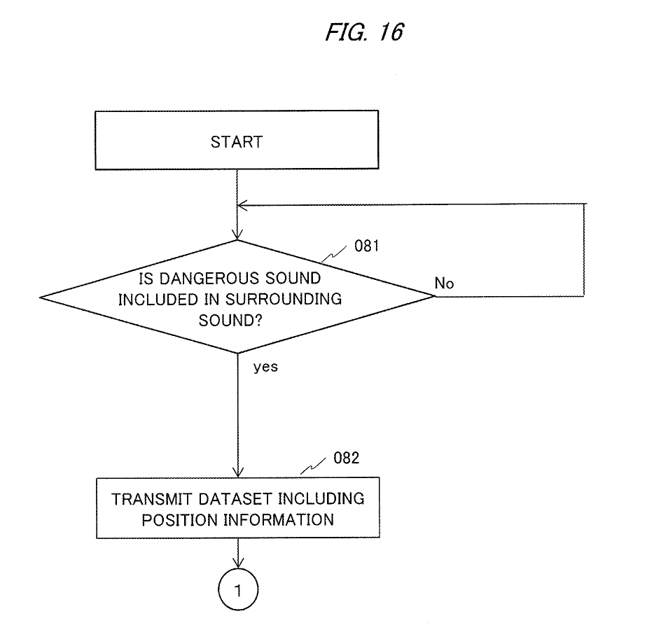

FIG. 16 is a flowchart illustrating a processing example of the terminal 1 relating to the notification of the position of the dangerous person. The processing illustrated in FIG. 16 is executed by the CPU 21 of the terminal 1. The CPU 21 performs sound analysis of surrounding sound of the terminal 1 collected by the microphone included in the input device 27 of the terminal 1, and determines whether or not a dangerous sound (for example, a shooting sound) is included in the surrounding sound (081).

In the case that the dangerous sound is included, the CPU 21 forms the dataset including the position information of the terminal 1 and transmits it to the server 6 (082). The dataset includes, in addition to the position information of the terminal 1, the type of an event (detection of the shooting sound) and a transmission request of the danger notification.

In the server 6 which receives the dataset, the processing of 074 illustrated in FIG. 15 is performed according to the transmission request of the danger notification, and the danger notification is transmitted to the respective terminals (one or more terminals) present (positioned) in the predetermined range from the position of the terminal 1 which detects the dangerous sound. The carrier of the terminal 1 which receives the danger notification can take an action of being careful or being on guard in response to the dangerous sound (the detection of the shooting sound).

The terminal 1 which detects the dangerous sound is one example of “a second terminal” or “a specific terminal”. The detection of the dangerous sound is one example of “an event detected by the second terminal”. Note that, in the example in FIG. 16, the detection of the dangerous sound is detected as the event. Instead of such a configuration, the terminal 1 may be provided with a sensor according to the event of a detection target and the dataset may be transmitted in the case that sensor output meaning event detection is obtained in 081.

### Embodiment 3

Next, the embodiment 3 will be described. Since the embodiment 3 includes the common points with the embodiment 1, the differences will be mainly described and the description is omitted for the common points. In the embodiment 3, the base station 2 determines the danger and the priority degree. In other words, while the server 6 is “the information processing apparatus (the transmission control device for the danger notification)” in the embodiment 1, the base station 2 is “the information processing apparatus (the transmission control device for the danger notification)” in the embodiment 3.

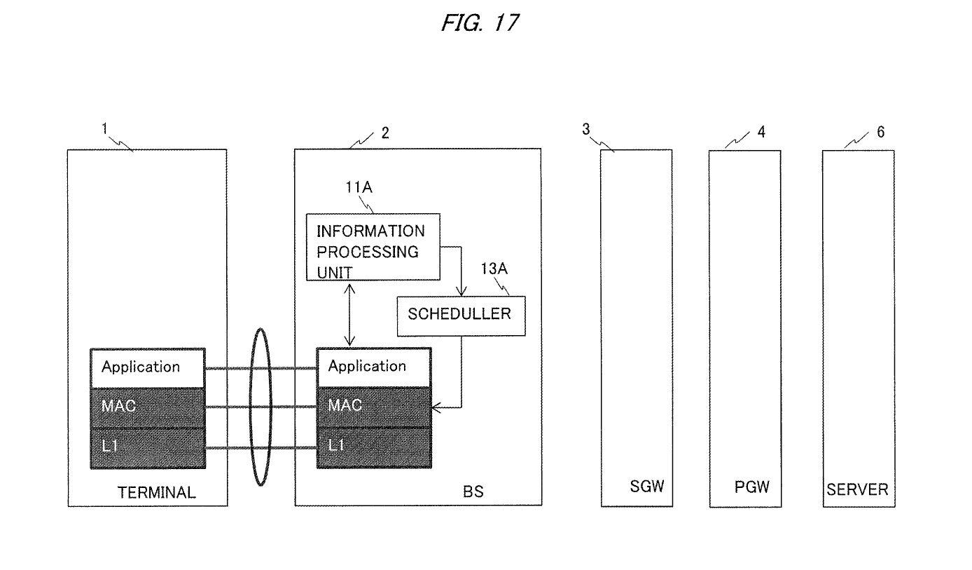

FIG. 17 schematically illustrates a configuration example in the case of the embodiment 3 (danger determination control in the base station). As illustrated in FIG. 17, the dataset and the danger notification including the position information described in the embodiment 1 are performed by MAC communication between the terminal 1 and the base station 2. In the embodiment 3, the terminal 1 and the base station 2 are connected by the physical layer (L1), the MAC layer and the application layer.

The danger and priority degree determination (the processing in the application layer) performed in the server 6 is, as one example, performed by an information processing unit 11A (the CPU 11 operated as the information processing unit 11A (FIG. 2)) included in the base station 2. The DSP 13 is operated as a scheduler 13A. The processing in the MAC layer is performed by the DSP 15.

That is, the DSP 15 can be operated as a MAC processing unit that performs the processing in the MAC layer, and performs the transmission and reception processing of a MAC-PDU (including a MAC-SDU). The dataset including the position information of the terminal obtained from the MAC-PDU is stored in the memory 12 through the CPU 11, without interposing the CPU 11.

The base station 2 periodically or cyclically collects the dataset including the position information of the terminal 1 (the pedestrian, the vehicle), and stores it in the memory 12. The base station 2 determines the danger and the priority degree and transmits the danger notification to the terminal 1 having the predetermined priority degree.

In the embodiment 3, a collection method of the dataset including the position information as follows is performed. The base station 2 periodically transmits UL grant to the terminal 1 (the mobile terminal 1A, the in-vehicle terminal 1B). The UL grant is physical control channel information including a permission for the terminal 1 to transmit the data to the base station (perform uplink (UL) transmission) and specification of the wireless resource used for the UL transmission, and functions as UL transmission permission notification.

The in-vehicle terminal 1B which receives the UL grant transmits transmission data (the dataset including the position information) using the specified wireless resource. The in-vehicle terminal 1B which receives the UL grant mounts the dataset including the latest position, speed and advancing direction of the present vehicle on the MAC-PDU and transmits it to the base station 2.

The mobile terminal 1A (pedestrian) which receives the UL grant mounts the dataset including the latest position information on the MAC-PDU and transmits it to the base station 2. The reception of the speed and the advancing direction from the terminal 1 of the pedestrian is avoided and an information amount transmitted by the mobile terminal 1A is reduced. By using the UL grant, the base station 2 can receive the dataset from the respective terminals 1 at desired timing.

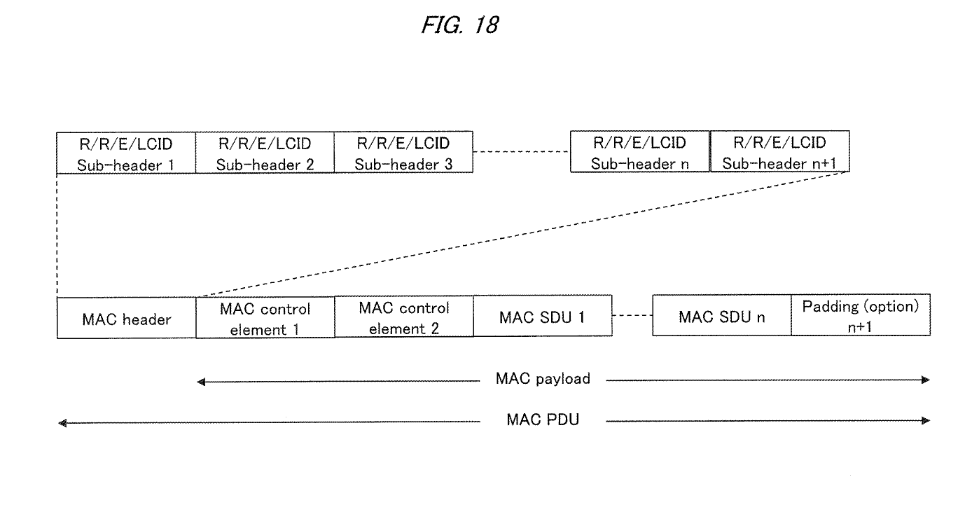

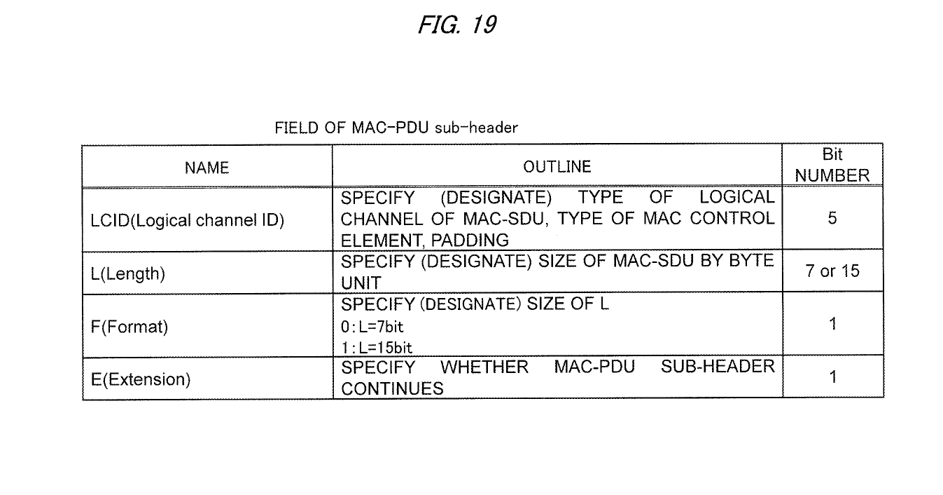

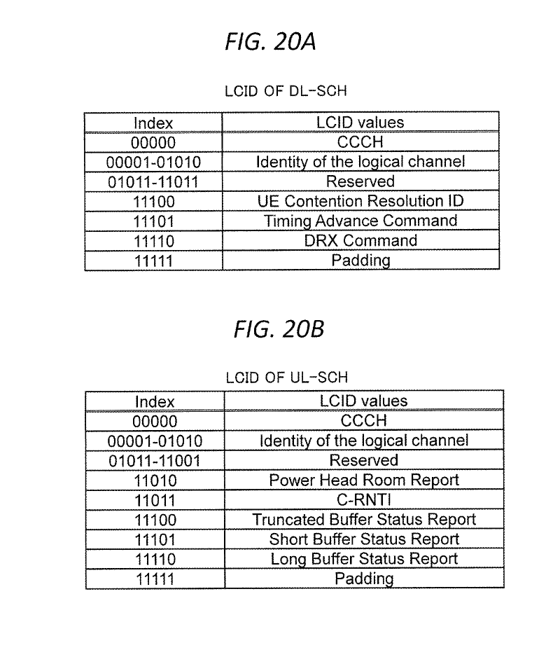

FIG. 18 is an explanatory drawing of the MAC-PDU (MAC Protocol Data Unit), and FIG. 19 is a table explaining a MAC header. FIG. 20A is a table illustrating the value of an LCID (Logical Channel identifier) of a DL-SCH (Downlink-Shared Channel), and FIG. 20B is a table illustrating the value of the LCID of an UL-SCH (Uplink-Shared Channel).

The MAC-PDU is, as illustrated in FIG. 18, formed of the MAC header and a MAC payload. The MAC header is formed of zero or one or more MAC-PDU sub-headers. The MAC payload is formed of zero, one or more MAC control elements and/or MAC-SDU. In the case that a size of the MAC-PDU is smaller than an allocated transport block (TB) size, padding (Padding) is inserted.

The MAC-SDU is made to correspond to one of the MAC-PDU sub-headers provided in the MAC header. The MAC-PDU sub-header includes the plurality of identifiers. The identifiers are the LCID, L (length), F (format), and E (extension).

As illustrated in FIG. 19, the LCID is used for specifying the type of a logical channel of the MAC-SDU, the type of the MAC control element or the padding. The LCID has five bits and “00001” to “01010” are used for the identification of the logical channel (see FIGS. 20A and 20B).

The LCID of the DL-SCH has the values (“01011” to “11001”) of “Reserved” for which a use is not determined (see FIG. 20A). One of the values of “Reserved” is used as the identifier of “the danger notification”.

By the recognition of the LCID indicating “the danger notification” in the terminal 1, the reception of the danger notification can be detected. Therefore, the transmission of the MAC-SDU corresponding to the LCID of “the danger notification” is optional. By avoiding MAC-SDU transmission, a communication data amount is reduced and the processing is reduced.

However, as an option, the position information [longitude (XXX degrees YY.ZZZZ minutes), latitude (XX degrees YY.ZZZZZ minutes), height (XXXX.Y)], the moving direction [angle (degrees) based on north], and the speed information [km/s] of an object which is a dangerous object can be included as the downlink (DL) MAC-SDU.

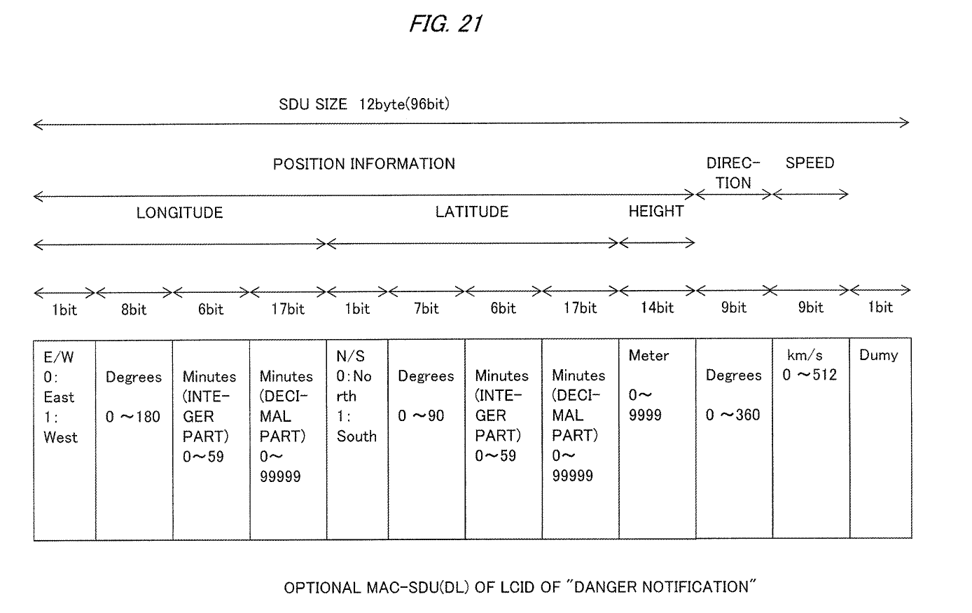

FIG. 21 illustrates a format example of an optional MAC-SDU(DL) corresponding to the LCID of the danger notification. As illustrated in FIG. 21, the position information (latitude and longitude coordinate information), the speed and the direction are mapped.

The LCID of the UL-SCH also has the values (“01011” to “11001”) of “Reserved” for which the use is not determined (see FIG. 20B). One of the values of “Reserved” is used as the identifier (the LCID of “an information report”) indicating that the corresponding MAC-SDU includes the position information (dataset).

The terminal 1 transmits the MAC-PDU for which the LCID of “an information response report” is imparted to the MAC header to the base station 2. In order to suppress the data amount, transmission content is made different between the in-vehicle terminal 1B and the mobile terminal 1A of the pedestrian.

Since the vehicle speed is higher than a walking speed, from the in-vehicle terminal (the in-vehicle terminal 1B, the mobile terminal 1A loaded in the vehicle), the dataset including a terminal identifier indicating “in-vehicle”, the position information, the moving direction and the speed is transmitted.

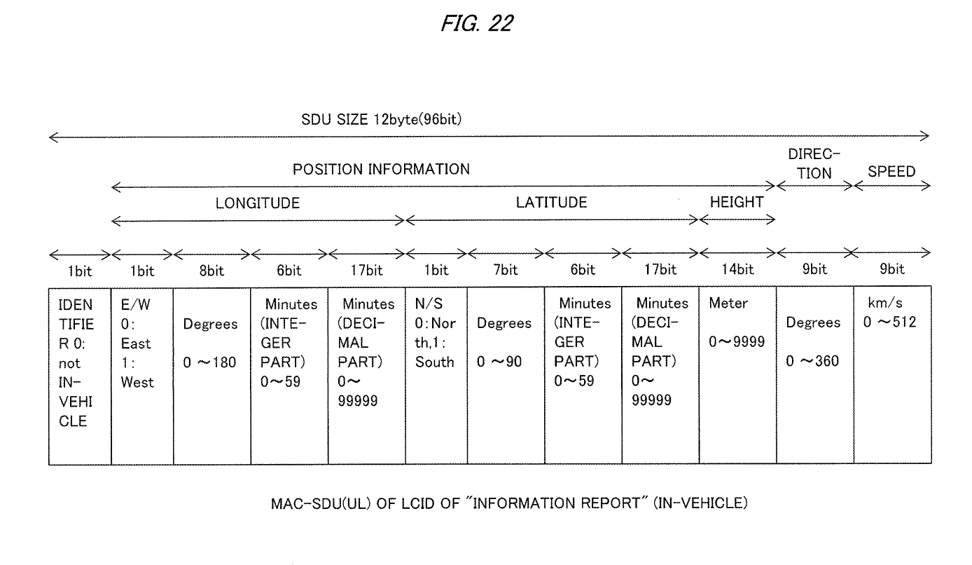

FIG. 22 illustrates a format example of the MAC-SDU mounted on an uplink MAC-PDU for which the LCID of “the information report” is imparted to the MAC header, which is transmitted from the in-vehicle terminal. The MAC-SDU includes the identifier of “in-vehicle”, the position information [longitude (XXX degrees YY.ZZZZ minutes), latitude (XX degrees YY.ZZZZZ minutes), height (XXXX.Y)], the moving direction [angle (degrees) based on north], and the speed information [km/s].

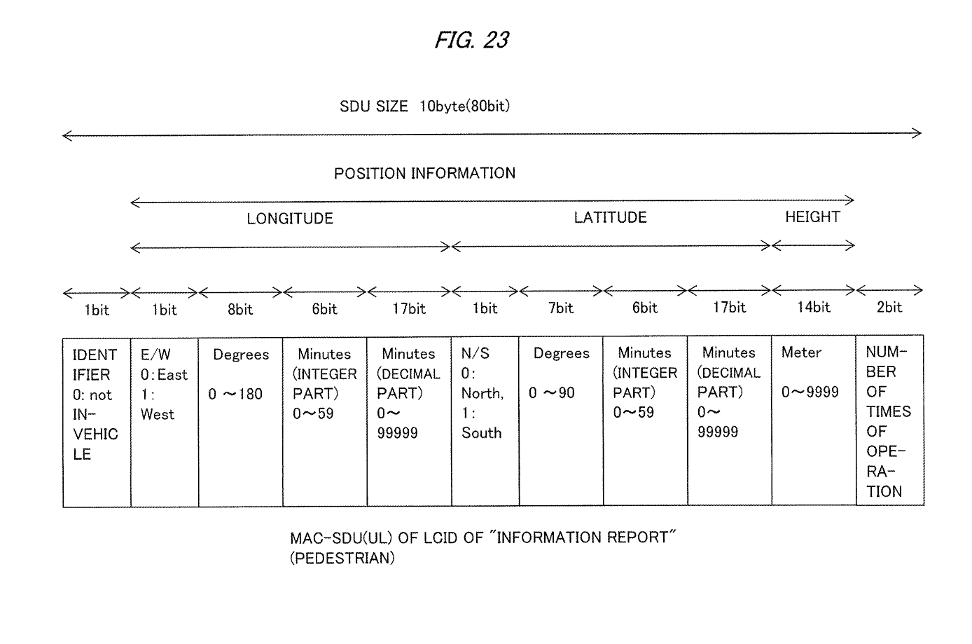

For the terminal 1 of the pedestrian, since the walking speed is lower than the vehicle speed and the number of the pedestrians is often larger than the number of the vehicles, the speed and the direction are not included in the transmission target. FIG. 23 illustrates a format example of the MAC-SDU mounted on the uplink MAC-PDU for which the LCID of “the information report” is imparted to the MAC header, which is transmitted from the terminal of the pedestrian. The MAC-SDU includes the identifier indicating that it is not “in-vehicle”, and the position information [longitude (XXX degrees YY.ZZZZ minutes), latitude (XX degrees YY.ZZZZZ minutes), height (XXXX.Y)].

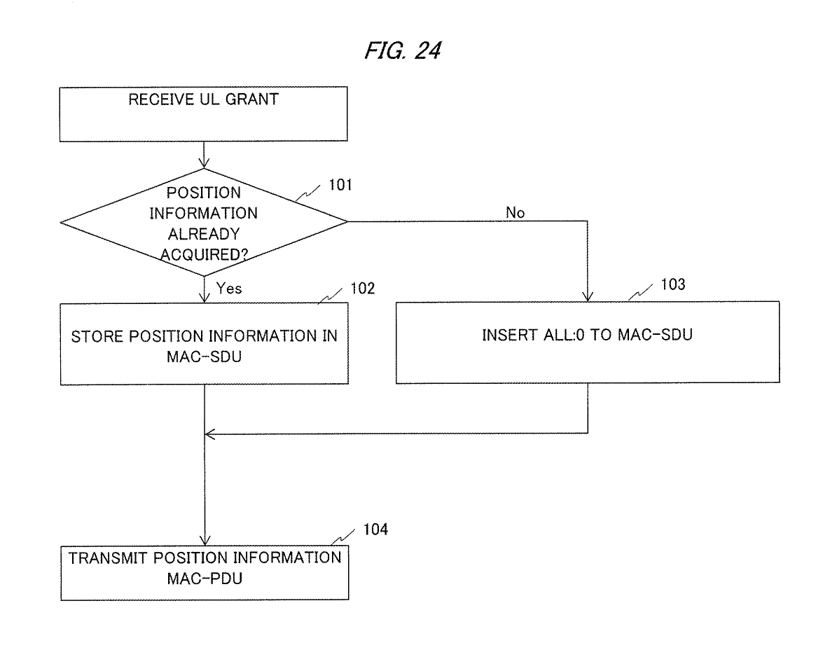

Transfer of the dataset including the position information of the terminal 1 and the base station 2 will be described. FIG. 24 is a flowchart illustrating a processing example when transmitting the dataset in the terminal 1. The processing in FIG. 24 is started with the reception of the UL grant from the base station 2 by the terminal 1 as a trigger.

In 101, the terminal 1 determines whether the position information is acquired by the GPS receiver 26. The processing advances to 102 in the case that the position information is not acquired, and the processing advances to 103 otherwise.

In 102, the position information is stored in the MAC-SDU. In 103, ALL: 0 (all 0) is set as the value of a field to mount the position information in the MAC-SDU. However, in the case that the position information of the device (for example, the car navigation device or the like) other than the terminal 1 can be diverted, such position information may be stored in the MAC-SDU. Note that, in 102 and 103, the MAC-SDU based on the format illustrated in FIG. 22 or FIG. 23 is generated.

In 104, the MAC-PDU which includes the MAC-SDU generated in 102 and 103 and for which the LCID of “the information report” is set is generated and is transmitted to the base station 2.

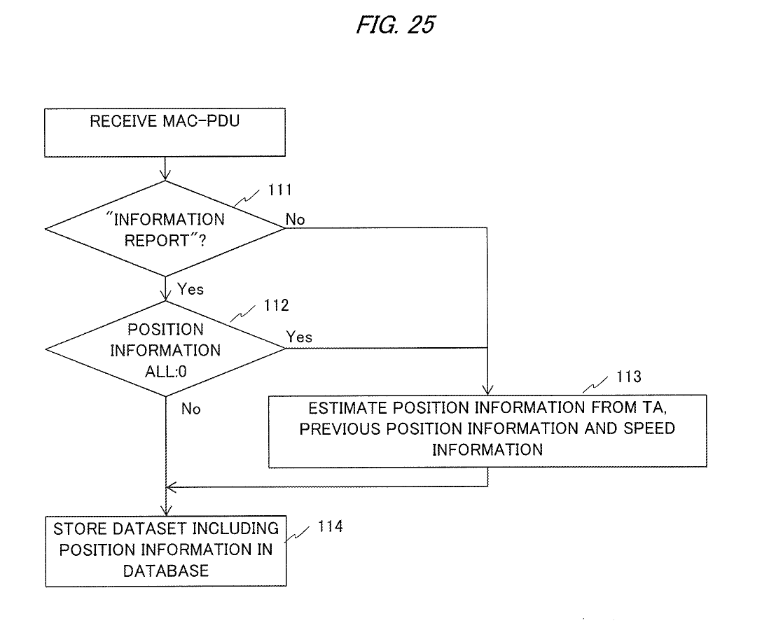

FIG. 25 is a flowchart illustrating a processing example when receiving the MAC-PDU in the base station 2. In 111, whether it is the MAC-PDU for which the LCID of “the information report” is set to the MAC header of the MAC-PDU is determined. The processing advances to 112 when it is determined that it is the MAC-PDU for which the LCID of “the information report” is set, and the processing advances to 113 otherwise.

In 112, whether or not the values of the field of the position information of the MAC-SDU corresponding to the LCID of “the information report” are all 0 is determined. The processing advances to 113 in the case that the values of the field of the position information are all 0, and the processing advances to 114 otherwise.

In 113, the position information is not acquired since the values of the field of the position information are all 0, so that the position information is estimated from Timing Advance (TA) and the previous position and speed information (stored in the memory). The TA is an amount (parameter) used for adjusting the transmission timing of the terminal 1. In 114, the dataset including the position information is stored in a database. The database is prepared on the memory 12.

The information processing unit 11A performs the processing similar to the processing illustrated in FIG. 6, FIG. 7 and FIG. 8, and determines the priority degree regarding the terminal 1, determines the necessity of the danger notification, and updates a cycle of information updating. The detailed description of the processing is omitted since it is redundant.

For a start trigger of the processing in FIG. 6, the processing is started when the collection cycle of the dataset ends or in the case that the UL grant is transmitted to a specific terminal 1 by a request from the terminal 1 or spontaneously and the dataset transmitted in response to the UL grant is acquired. Note that the UL grant is transmitted when the transmission of the UL grant is requested from the terminal 1 even within the collection cycle.

In the processing of 001, whether or not it is in-vehicle may be determined by a difference (FIG. 22, FIG. 23) in the format of the MAC-PDU, or may be determined based on the identifier of “in-vehicle” of the MAC-SDU. In 004, the transmission cycle of the UL grant to the terminal 1 is changed (updated) according to the priority degree.

In the case of transmitting the danger notification to the terminals 1 of the priority degrees “1”-“4” in 006, the LCID of “the danger notification” (and the optional MAC-SDU) is set to the MAC-PDU preferentially (by interruption for example) by the scheduler 13A (FIG. 17). In this way, by performing scheduling of preferentially transmitting the MAC-PDU including the information indicating that it is the danger notification, the arrival timing of the danger notification at the terminal 1 can be advanced.

Now, there is a case that the terminal 1 is in a state (DRX state) of receiving the data in a cycle of several seconds to several ten minutes (the data is not received in between), called Discontinuous Reception (DRX). Whether or not the terminal 1 is in the DRX state is managed in the base station 2.

When a range of danger increase starts though the danger that the pedestrian and the vehicle collide is still low and the terminal 1 is in the DRX state (in the case that a predetermined condition is satisfied), the base station 2 sends a canceling instruction for the DRX state to the terminal 1 in the DRX state. The canceling instruction is, for example, a message of RRC (Radio Resource Control). The terminal 1 which receives the canceling instruction cancels (turns OFF) the DRX state. By canceling the DRX state, the terminal 1 is turned to a state capable of receiving the danger notification anytime. In addition, in the case of transmitting the danger notification to the terminal 1, the base station 2 can select a more highly reliable lte TBS (Transport Block Size), a modulation system, and the number of antennas.

According to the embodiment 3, since a transmission distance of the position information and a transmission distance of the danger notification become short, a transmission delay can be made shorter than that in the embodiment 1. Thus, the danger notification to the terminal 1 (the driver, the pedestrian) at the appropriate time becomes easy compared to the embodiment 1.

The configurations of the embodiments 1 to 3 described above can be appropriately combined. In particular the configuration of the embodiment 3 can be combined with the embodiment 2.

According to the embodiments, it can be made a transmission destination and transmission opportunity of information appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to:
setting a priority degree of transmission of information to be notified to each of a plurality of terminals including an in-vehicle terminal and terminals carried by pedestrians based on position information of the plurality of terminals; and
transmitting the information to the terminal having a predetermined priority degree among the plurality of terminals when it is determined that the information needs to be transmitted based on a position of the in-vehicle terminal.

2. The information processing apparatus according to claim 1, wherein the processor is configured to change a cycle of collecting a dataset including the position information from the plurality of terminals according to the priority degree.

3. The information processing apparatus according to claim 1, wherein the processor is configured to determine the transmission of the information when there is a terminal having the priority degree of a predetermined priority order or higher in the plurality of terminals.

4. The information processing apparatus according to claim 1, wherein the processor is configured to set the predetermined priority degree to the in-vehicle terminal when it is determined that a vehicle loaded with the in-vehicle terminal is approaching a predetermined spot without speed reduction.

5. The information processing apparatus according to claim 4, wherein the processor is configured to set the predetermined priority degree to the terminal positioned in a predetermined range from the predetermined spot among the terminals carried by the pedestrians.

6. The information processing apparatus according to claim 5, wherein the processor is configured to set the priority degree higher than the priority degree of the terminal in a non-use state to the terminal in use among the terminals positioned in the predetermined range from the predetermined spot.

7. The information processing apparatus according to claim 1, wherein the processor is configured to perform processing of transmitting the information to the terminal having the predetermined priority degree, in the case that a transmission request of the information is received based on an image for which a predetermined range is photographed from the predetermined spot.

8. The information processing apparatus according to claim 1, wherein the information processing apparatus is a base station that performs wireless communications with the plurality of terminals.

9. The information processing apparatus according to claim 8, further comprising a MAC processing unit configured to:
receive a MAC-PDU including position information of each terminal from each of the plurality of terminals; and
transmit the MAC-PDU including the information to the terminal having the predetermined priority degree.

10. The information processing apparatus according to claim 9, wherein the MAC processing unit is configured to transmit UL grant that urges transmission of the MAC-PDU including the position information of the terminal to each of the plurality of terminals.

11. The information processing apparatus according to claim 9, wherein the MAC processing unit is configured to receive the MAC-PDU including information indicating a moving speed of the terminal further from the in-vehicle terminal among the plurality of terminals.

12. The information processing apparatus according to claim 9, further comprising a scheduler configured to perform scheduling of preferentially transmitting the MAC-PDU including the information.

13. The information processing apparatus according to claim 1, wherein the processor is configured to transmit information to one of the plurality of terminals, when one of the plurality of terminals is carried by a single pedestrian, and there is a person moving in a direction of approaching the single pedestrian at a moving speed higher than a moving speed of the single pedestrian in a predetermined range from the single pedestrian.

14. The information processing apparatus according to claim 1, wherein the processor is configured to transmit information to one or more terminals positioned in a predetermined range from a position of a first terminal carried by a predetermined person when position information of the first terminal is received.

15. The information processing apparatus according to claim 1, wherein the processor is configured to transmit a danger notification to one or more terminals positioned in a predetermined range from a position of a specific terminal when receiving a transmission request of a danger notification based on an event detected by the specific terminal with the position information of the specific terminal,

16. A transmission control method of danger notification, the method comprising:
setting, using a processor coupled to a meonory, a priority degree of the danger notification to each of a plurality of terminals including an in-vehicle terminal and terminals carried by pedestrians based on position information of the plurality of terminals; and
transmitting, using the processor, the danger notification to the terminal having a predetermined priority degree among the plurality of terminals when it is determined that the danger notification needs to be transmitted based on the position of the in-vehicle terminal.

17. A terminal that communicates with an information processing apparatus that controls transmission of information, the terminal comprising:
a transmitter that transmits position information of the terminal; and
a receiver that receives the information in the case that a predetermined priority degree among priority degrees of transmission of the information is set based on the position information of the terminal and the transmission of the information to the terminal having the predetermined priority degree among the plurality of terminals is determined based on the position information of an in-vehicle terminal.
